(19) United States
(12) Patent Application Publication
(10) Pub. No.: US 2026/0362187 A1
(43) Pub. Date: Nov. 12, 2026

(54) RRM MEASUREMENT PERFORMANCE TESTING METHOD AND APPARATUS, TERMINAL, NETWORK SIDE DEVICE, AND MEDIUM

(71) Applicant: VIVO MOBILE COMMUNICATION CO., LTD., Dongguan (CN)

(72) Inventor: Xusheng WEI, Dongguan (CN)

(21) Appl. No.: 19/720,951

(22) Filed: Jun. 26, 2026

Related U.S. Application Data
(63) Continuation of application No. PCT/CN2024/143655, filed on Dec. 30, 2024.

(30) Foreign Application Priority Data
Dec. 28, 2023 (CN) 202311844715.0

(51) Int. Cl. H04W 24/08

(52) U.S. Cl. CPC H04W 24/08

(57) ABSTRACT

Provided are an RRM measurement performance test method, an RRM measurement performance test apparatus, a terminal, a network side device, and a computer-readable storage medium. The method includes: performing, by a first receiving unit of a terminal, first RRM measurement on a first cell in response to reception of a test signal sent by a network side device, where an operating power of the first receiving unit meets a first preset condition; and in a case that a measurement result of the first RRM measurement meets a second preset condition, starting, by the terminal, a second receiving unit, and performing second RRM measurement by using the second receiving unit so as to perform cell reselection, where access information of the terminal in a second cell is used to determine a test result of RRM measurement performance of the terminal.

### CROSS-REFERENCE TO RELATED APPLICATIONS

This application is a continuation of International Patent Application No. PCT/CN2024/143655, filed on Dec. 30, 2024, which claims priority to Chinese Patent Application No. 202311844715.0, filed with the Chinese Patent Office on Dec. 28, 2023 and entitled “RRM MEASUREMENT PERFORMANCE TESTING METHOD AND APPARATUS, TERMINAL, NETWORK SIDE DEVICE, AND MEDIUM”, both of which are incorporated herein by reference in their entireties.

### TECHNICAL FIELD

This application pertains to the field of communication technologies, and specifically relates to a Radio Resource Management (RRM) measurement performance test method, an RRM measurement performance test apparatus, a terminal, a network side device, and a computer-readable storage medium.

### BACKGROUND

In a case that a terminal is deployed with a low power receiver, RRM measurement on a cell may be performed by the low power receiver. Further, the low power receiver determines, according to a measurement result, whether to wake up a primary receiver of the terminal.

### SUMMARY

Embodiments of this application provide an RRM measurement performance test method, an RRM measurement performance test apparatus, a terminal, a network side device, and a computer-readable storage medium.

According to a first aspect, an RRM measurement performance test method is provided and is executed by a terminal. The method includes: performing, by a first receiving unit of a terminal, first RRM measurement on a first cell in response to reception of a test signal sent by a network side device, where an operating power of the first receiving unit meets a first preset condition; and in a case that a measurement result of the first RRM measurement meets a second preset condition, starting, by the terminal, a second receiving unit, and performing second RRM measurement by using the second receiving unit so as to perform cell reselection, where access information of the terminal in a second cell is used to determine a test result of RRM measurement performance of the terminal.

According to a second aspect, an RRM measurement performance test method is provided, and is executed by a network side device. The method includes: sending, by a network side device, a test signal to a terminal, so that a first receiving unit of the terminal performs first RRM measurement on a first cell in response to reception of the test signal, where an operating power of the first receiving unit meets a first preset condition; and in a case that a measurement result of the first RRM measurement meets a second preset condition, the terminal starts a second receiving unit, and performs second RRM measurement by using the second receiving unit so as to perform cell reselection, where access information of the terminal in a second cell is used to determine a test result of RRM measurement performance of the terminal.

According to a third aspect, an RRM measurement performance test apparatus is provided. The apparatus includes an RRM measurement module and a cell reselection module. The RRM measurement module is configured to perform first RRM measurement on a first cell in response to a first receiving unit of a terminal receiving a test signal sent by a network side device, where an operating power of the first receiving unit meets a first preset condition; and the cell reselection module is configured to: in a case that a measurement result of the first RRM measurement meets a second preset condition, start, by the terminal, a second receiving unit, and perform second RRM measurement by using the second receiving unit so as to perform cell reselection, where access information of the terminal in a second cell is used to determine a test result of RRM measurement performance of the terminal.

According to a fourth aspect, an RRM measurement performance test apparatus is provided. The apparatus includes a sending module. The sending module is configured to send, by a network side device, a test signal to a terminal, so that a first receiving unit of the terminal performs first RRM measurement on a first cell in response to reception of the test signal, where an operating power of the first receiving unit meets a first preset condition; and in a case that a measurement result of the first RRM measurement meets a second preset condition, the terminal starts a second receiving unit, and performs second RRM measurement by using the second receiving unit so as to perform cell reselection, where access information of the terminal in a second cell is used to determine a test result of RRM measurement performance of the terminal.

According to a fifth aspect, a terminal is provided. The terminal includes a processor and a memory, the memory stores a program or an instruction that can be run on the processor, and the program or the instruction is executed by the processor to implement the steps of the RRM measurement performance test method provided in the first aspect.

According to a sixth aspect, a terminal is provided, including a processor and a communication interface. The processor is configured to perform the steps of the RRM measurement performance test method provided in the first aspect, and the communication interface is configured to perform information exchange with a network side device.

According to a seventh aspect, a network side device is provided. The network side device includes a processor and a memory, the memory stores a program or an instruction that can be run on the processor, and the program or the instruction is executed by the processor to implement the steps of the RRM measurement performance test method provided in the second aspect.

According to an eighth aspect, a network side device is provided, including a processor and a communication interface. The processor is configured to perform the steps of the RRM measurement performance test method provided in the second aspect, and the communication interface is configured to perform information exchange with a terminal device.

According to a ninth aspect, a readable storage medium is provided. The readable storage medium stores a program or an instruction, and the program or the instruction is executed by a processor to implement the steps of the RRM measurement performance test method provided in the first aspect or the steps of the RRM measurement performance test method provided in the second aspect.

According to a tenth aspect, a wireless communication system is provided, including a terminal and a network side device. The terminal may be configured to perform the steps of the RRM measurement performance test method provided in the first aspect, and the network side device may be configured to perform the steps of the RRM measurement performance test method provided in the second aspect.

According to an eleventh aspect, a chip is provided. The chip includes a processor and a communication interface, the communication interface is coupled to the processor, and the processor is configured to run a program or an instruction to implement the RRM measurement performance test method provided in the first aspect or the RRM measurement performance test method provided in the second aspect.

According to a twelfth aspect, a computer program/program product is provided. The computer program/program product is stored in a storage medium, and the program/program product is executed by at least one processor to implement the steps of the RRM measurement performance test method according to the first aspect or the RRM measurement performance test method according to the second aspect.

### BRIEF DESCRIPTION OF DRAWINGS

FIG. 1 is a schematic block diagram of a wireless communication system to which an embodiment of this application can be applied.

FIG. 2 is a schematic structural diagram of a terminal to which an embodiment of this application can be applied.

FIG. 3 is a schematic flowchart of an RRM measurement performance test method according to Embodiment 1 of this application.

FIG. 4 is a schematic diagram of a test signal according to an embodiment of this application.

FIG. 5 is a schematic flowchart of an RRM measurement performance test method according to Embodiment 2 of this application.

FIG. 6 is a schematic flowchart of an RRM measurement performance test method according to Embodiment 3 of this application.

FIG. 7 is a schematic flowchart of an RRM measurement performance test method according to Embodiment 4 of this application.

FIG. 8 is a schematic flowchart of an RRM measurement performance test method according to Embodiment 5 of this application.

FIG. 9 is a schematic flowchart of an RRM measurement performance test method according to Embodiment 6 of this application.

FIG. 10 is a schematic flowchart of an RRM measurement performance test method according to Embodiment 7 of this application.

FIG. 11 is a schematic flowchart of an RRM measurement performance test method according to Embodiment 8 of this application.

FIG. 12 is a schematic flowchart of an RRM measurement performance test method according to Embodiment 9 of this application.

FIG. 13 is a schematic flowchart of an RRM measurement performance test method according to Embodiment 10 of this application.

FIG. 14 is a schematic flowchart of an RRM measurement performance test method according to Embodiment 11 of this application.

FIG. 15 is a schematic flowchart of an RRM measurement performance test method according to Embodiment 12 of this application.

FIG. 16 is a schematic diagram of information exchange in an RRM measurement performance test method according to Embodiment 13 of this application.

FIG. 17 is a schematic diagram of information exchange in an RRM measurement performance test method according to Embodiment 14 of this application.

FIG. 18 is a schematic diagram of information exchange in an RRM measurement performance test method according to Embodiment 15 of this application.

FIG. 19 is a schematic diagram of information exchange in an RRM measurement performance test method according to Embodiment 16 of this application.

FIG. 20 is a schematic diagram of information exchange in an RRM measurement performance test method according to Embodiment 17 of this application.

FIG. 21 is a schematic structural diagram of an RRM measurement performance test apparatus according to Embodiment 18 of this application.

FIG. 22 is a schematic structural diagram of an RRM measurement performance test apparatus according to Embodiment 19 of this application.

FIG. 23 is a schematic structural diagram of a communication device according to Embodiment 20 of this application.

FIG. 24 is a schematic structural diagram of a terminal according to Embodiment 21 of this application.

FIG. 25 is a schematic structural diagram of a network side device according to Embodiment 22 of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2: including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as specific information, an operation to be performed, or a requested result in a sent indication. An indirect indication may be understood as that a recipient determines corresponding information based on an indication sent by a sender, or makes a judgment and determines an operation to be performed or a requested result based on a judgment result.

It should be noted that the positioning technology described in the embodiments of this application is not limited to a Long Term Evolution (LTE)/LTE-advanced (LTE-A) system, and may be further applied to another wireless communication system such as a global system for mobile communication (GSM) system, Code Division Multiple Access (CDMA), a wideband code division multiple access (WCDMA) system, a general packet radio service (GPRS), Time Division Multiple Access (TDMA), Frequency Division Multiple Access (FDMA), Orthogonal Frequency Division Multiple Access (OFDMA), Single-carrier Frequency-Division Multiple Access (SC-FDMA), or another system. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to systems other than the NR system, such as a 6th Generation (6G) communication system.

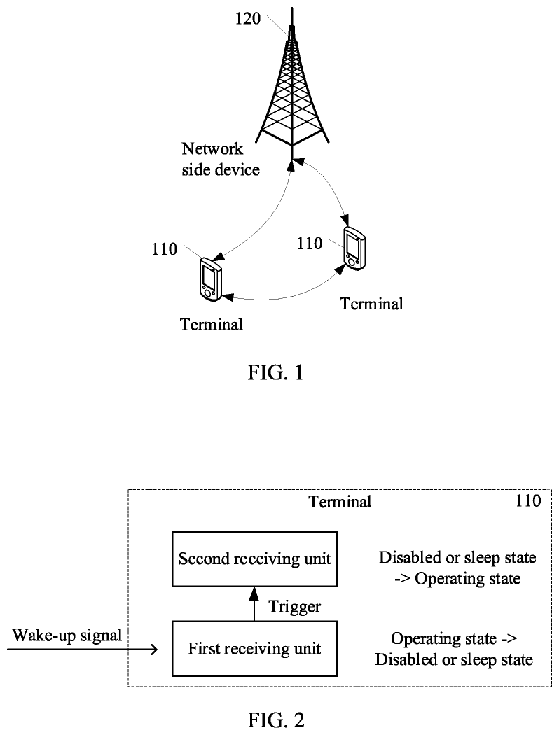

FIG. 1 is a block diagram of a wireless communication system to which the embodiments of this application can be applied. Referring to FIG. 1, the wireless communication system includes a terminal 110 and a network side device 120.

The network side device 120 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

In this application, the network side device 120 may be a test device, and is configured to send a test signal to a to-be-tested terminal. Further, the test signal is used to test RRM measurement performance of the terminal.

The terminal 110 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), shipborne equipment, Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a specific type of the terminal 110 is not limited in the embodiments of this application.

FIG. 2 is a schematic block diagram of a terminal 110 to which an embodiment of this application can be applied. Referring to FIG. 2, the terminal 110 includes a first receiving unit and a second receiving unit. A power of the first receiving unit meets a first preset condition. Specifically, the power of the first receiving unit is less than a preset value, which belongs to a low power receiving module, or a receiving unit with an almost “zero” power. Specifically, the receiving unit with the almost “zero” power does not perform signal detection (for example, amplification, filtering, and quantization) of a Radio Frequency (RF) module, complex baseband (MODEM) signal handling, and the like, but only performs passive matching filtering and signal processing with low power consumption. In some terminals, the first receiving unit and the second receiving unit belong to two modules in a same receiver. In some terminals, the first receiving unit and the second receiving unit are separate receivers. This is not limited in the embodiments of this application.

An example in which the first receiving unit and the second receiving unit belong to two modules in a same receiver is used for description. The receiver is a low power wake-up receiver (low power wake up radio, LP-WUR) or is referred to as an almost zero power receiver (almost zero power wake up radio, AZP-WUR). As shown in FIG. 2, the first receiving unit is a low power receiving module (also referred to as a low power wake-up receiving module or a low power receiver in the embodiments of this application), and is configured to receive a wake-up signal, such as a low power wake-up signal (low power wake up signal, LP-WUS). The second receiving unit is a primary communication module (also referred to as a primary receiver in the embodiments of this application), and is configured to send and receive mobile communication data. When the terminal 110 is in an energy-saving state (in a standby state), the primary communication module is disabled or enters a sleep state, and the low power receiving module is in a startup state to monitor the wake-up signal. When downlink data arrives at the terminal 110, the network side device 120 first sends a wake-up signal to the terminal 110. The terminal 110 in the energy-saving state detects the wake-up signal by using the low power receiving module, and then triggers, by means of a series of determining, the primary communication module from being disabled to being enabled or waked up. In this case, the low power receiving module enters a disabled state from an operating state. The low power wake-up receiving module may be continuously enabled, intermittently enabled, or the like, which is not limited in this embodiment of this application. Therefore, in a case that the terminal 110 is deployed with a low power receiver, power consumption of the terminal in a standby state can be reduced.

In a case that the terminal is deployed with the low power receiver, the low power receiver (the first receiving unit) performs RRM measurement on a serving cell. Further, the low power receiver (the first receiving unit) determines, according to a result of the RRM measurement, whether to wake the primary receiver (the second receiving unit). In the related technology, regarding the behavior that the low power receiver wakes up the primary receiver, a performance test scheme for this behavior is not available in the related technology. Therefore, providing a performance test scheme for behavior that a low power receiver wakes up a primary receiver is a problem that needs to be resolved.

The solution provided in this application can resolve the problem existing in the related technology. Specifically, in a case that a network side sends a test signal to a terminal, a low power receiver (a first receiving unit) of the terminal performs first RRM measurement on a first cell, so as to reduce power consumption of the terminal. Then, in a case that a measurement result of the first RRM measurement meets a second preset condition, the terminal starts a primary receiver (a second receiving unit), and performs second RRM measurement by using the second receiving unit, so as to perform cell reselection. Further, access information of the terminal in a second cell may be used to determine a test result of RRM measurement performance of the terminal. For example, that the terminal successfully accesses the second cell indicates that the first receiving unit successfully wakes up the second receiving unit in the RRM measurement process. It can be learned that the embodiments of this application can provide a performance test scheme for behavior that a low power receiver wakes up a primary receiver.

With reference to the accompanying drawings, the following describes in detail the RRM measurement performance test method provided in the embodiments of this application by using some embodiments and application scenarios thereof.

### Embodiment 1

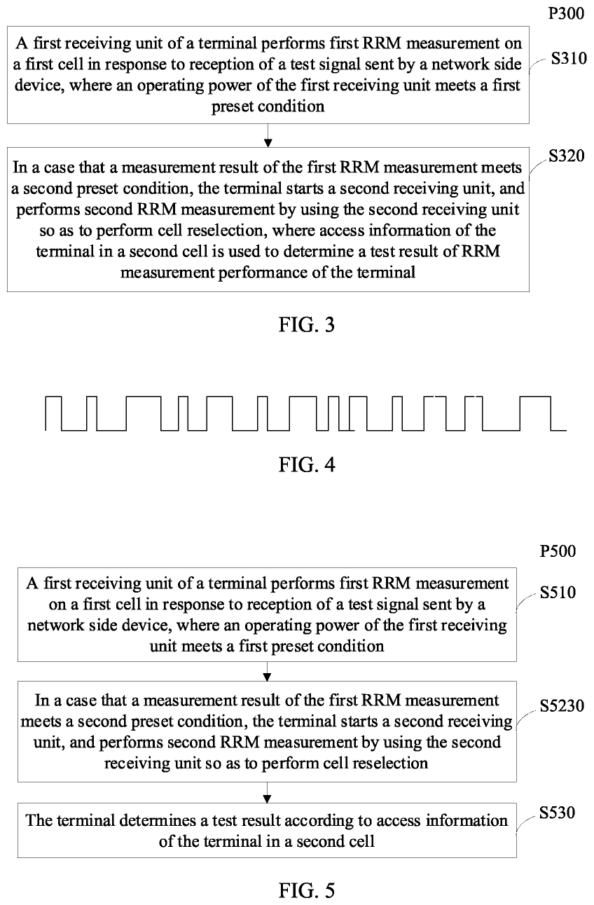

FIG. 3 is a schematic flowchart of an RRM measurement performance test method P300 according to Embodiment 1 of this application. The RRM measurement performance test method P300 is applied to a terminal. As shown in FIG. 3, the RRM measurement performance test method P300 provided in this embodiment includes the following steps.

S310. A first receiving unit of a terminal performs first RRM measurement on a first cell in response to reception of a test signal sent by a network side device, where an operating power of the first receiving unit meets a first preset condition.

In an exemplary embodiment, as shown in FIG. 2, the terminal may be deployed with the first receiving unit serving as a low power receiver and a second receiving unit serving as a primary receiver. As described above, the first receiving unit serving as a low power receiver does not perform signal detection (for example, amplification, filtering, and quantization) of a Radio Frequency (RF) module, complex baseband (MODEM) signal handling, and the like, but only performs passive matching filtering and signal processing with low power consumption. The operating power of the first receiving unit is less than a preset value, and the first receiving unit may be referred to as an almost “zero” receiver.

In an exemplary embodiment, the terminal is in a Radio Resource Control (RRC) idle mode or an RRC inactivate mode. For example, the first cell may be a cell in which the terminal 110 currently accesses or is located. To simplify description, the cell may also be referred to as this cell or a current cell of the terminal 110. For example, for the terminal 110 in an RRC idle mode or an RRC inactivate mode, the cell is a cell on which the terminal 110 camps. For another example, for a terminal in an RRC connected state, this cell is a serving cell of the terminal 110.

In an exemplary embodiment, the network side device may be a test device. A type of the signal that is sent by the network side device and that is used by the first receiving unit to perform the first RRM measurement includes at least one of the following: a low power wake-up signal LP-WUS or a Low Power Synchronization Signal (LP-SS). For example, the LP-WUS may be an on-off keying signal. FIG. 4 shows a time domain pattern in which the test signal used in the first RRM measurement process is an LP-WUS. It can be understood that the type of the test signal used in the first RRM measurement process is not limited to the foregoing, and may be another type. This is not limited in this embodiment of this application.

For example, the test signal (including a “first test signal” and a “second test signal” in the following embodiments) is a signal used by the first receiving unit to perform the first RRM measurement, and may be specifically a signal with a specific test parameter, or may be a signal with a random parameter determined according to an actual scenario. This is not limited in this embodiment of this application.

For example, the first receiving unit (a low power receiver) may determine, by means of energy detection, sequence detection identification, or payload detection, that the test signal is received.

For example, in a case that the first receiving unit (a low power receiver) receives the test signal, RRM performance measurement may be performed by using the received test signal. For example, in a case that the received test signal is an LP-SS, at least one of Reference Signal Received Power (RSRP) measurement, Reference Signal Received Quality (RSRQ) measurement, Signal to Interference plus Noise Ratio (SINR) measurement, and Receive Signal Strength Indication (RSSI) measurement is performed.

It should be noted that, in a process in which the first receiving unit (a low power receiver) performs the first RRM measurement on the first cell, the second receiving unit (a primary receiver) is in a power-off state or a sleep state to maintain low power consumption, thereby implementing power saving by receiving a wake-up signal. Therefore, radio frequency transmit/receive processing and baseband processing by the second receiving unit (a primary receiver) can be avoided or reduced, thereby implementing energy saving of the terminal.

S320. In a case that a measurement result of the first RRM measurement meets a second preset condition, the terminal starts a second receiving unit, and performs second RRM measurement by using the second receiving unit so as to perform cell reselection, where access information of the terminal in a second cell is used to determine a test result of RRM measurement performance of the terminal.

In an exemplary embodiment, the second preset condition may be that the result of the first RRM measurement reaches a preset threshold or a preset threshold range. If the measurement result of the first RRM measurement meets the second preset condition, it indicates that network quality of the current cell is poor, and the second receiving unit (a primary receiver) needs to be waked up so as to perform cell reselection.

For example, the result of the first RRM measurement may be represented by at least one of an RSRP, an RSRQ, an SINR, or an RSSI. A corresponding threshold may be defined for each measurement result. When at least one measurement result meets a corresponding threshold or threshold range, the terminal 110 needs to wake up the second receiving unit (a primary receiver) so as to perform cell reselection.

In an exemplary embodiment, the second receiving unit simultaneously performs the second RRM measurement on the first cell and a neighboring cell of the first cell according to the test signal (denoted as a “third test signal”) sent by the network side device. In the second RRM measurement process, the third test signal sent by the network side device needs to meet that network quality of at least one neighboring cell (intra-frequency or inter-frequency) is greater than the network signal quality of the first cell, so as to meet a test requirement for cell reselection. For example, the second cell with high network quality is determined in the at least one neighboring cell by means of cell reselection.

Further, the access information of the terminal 110 in the second cell is used to determine the test result of the RRM measurement performance of the terminal. For example, the test result may be determined by the terminal 110, or may be determined by the network side device 120 serving as a test device, thereby improving test flexibility. Embodiments of this application are separately described in the following embodiments.

In the scheme provided in the method P300, a first receiving unit of a terminal is in a startup phase to monitor a test signal sent by a network side device, and a second receiving unit is in a sleep state. The first receiving unit performs first RRM measurement on a first cell in a case that the test signal sent by the network side to the terminal is detected. In a case that a measurement result of the first RRM measurement meets a second preset condition, the terminal starts the second receiving unit, and performs second RRM measurement by using the second receiving unit so as to perform cell reselection. Further, access information of the terminal in a second cell may be used to determine a test result of RRM measurement performance of the terminal. For example, that the terminal successfully accesses the second cell indicates that the first receiving unit successfully wakes up the second receiving unit in the RRM measurement process. It can be learned that this embodiment of this application can provide a performance test scheme for behavior that a low power receiver wakes up a primary receiver.

### Embodiment 2

Based on Embodiment 1, Embodiment 2 of this application provides an RRM measurement performance test method. The implementations described in Embodiment 1 may be applied to Embodiment 2, and a same technical effect can be achieved. In this embodiment, a terminal determines a test result. FIG. 5 is a flowchart of an RRM measurement performance test method P500 according to Embodiment 2 of this application. As shown in FIG. 5, the RRM measurement performance test method P500 provided in this embodiment includes the following steps.
S510. A first receiving unit of a terminal performs first RRM measurement on a first cell in response to reception of a test signal sent by a network side device, where an operating power of the first receiving unit meets a first preset condition.

A specific implementation of S510 is the same as the specific implementation of S310, and details are not described herein again.
S520. In a case that a measurement result of the first RRM measurement meets a second preset condition, the terminal starts a second receiving unit, and performs second RRM measurement by using the second receiving unit so as to perform cell reselection.

A specific implementation of S520 is the same as the specific implementation of S320, and details are not described herein again.
S530. The terminal determines a test result according to access information of the terminal in a second cell.

As described above, the second cell is a neighboring cell of the first cell. The first receiving unit of the terminal 110 wakes up the second receiving unit of the terminal 110 when determining that network quality of the first cell is poor. The second receiving unit executes the second RRM strategy to perform cell reselection and access a network of the second cell. Further, after camping on the second cell, the terminal 110 determines the test result according to the access information of the terminal 110 in the second cell.
S530-1. After camping on the second cell, the terminal 110 obtains a number of accesses on a Random Access Channel (RACH) initiated by the second receiving unit within preset duration. An RACH is an uplink transmission channel, and is a first message sent by UE to an eNB when the terminal 110 is started. In all cellular technologies (CDMA, GSM, WCDMA, and LTE), a signal similar to the RACH is used as the first message sent by the UE to the eNB, and this message is applicable to the embodiments of this application.
S530-2. Determine a test result of RRM measurement performance of the terminal according to the number of accesses.

For example, if the number of accesses on the RACH of the terminal within the preset duration is less than a preset number of times, it indicates that the terminal 110 successfully accesses the second cell. Therefore, it is proved that the first receiving unit of the terminal successfully wakes up the second receiving unit after determining that the second RRM is performed on the first cell. It can be learned that this embodiment of this application can provide a performance test scheme for behavior that a low power receiver wakes up a primary receiver.

In an exemplary embodiment, after determining the test result, the terminal 110 may further send the test result to the network side device 120 for storage, so as to facilitate statistical processing and the like of the test result.

### Embodiment 3

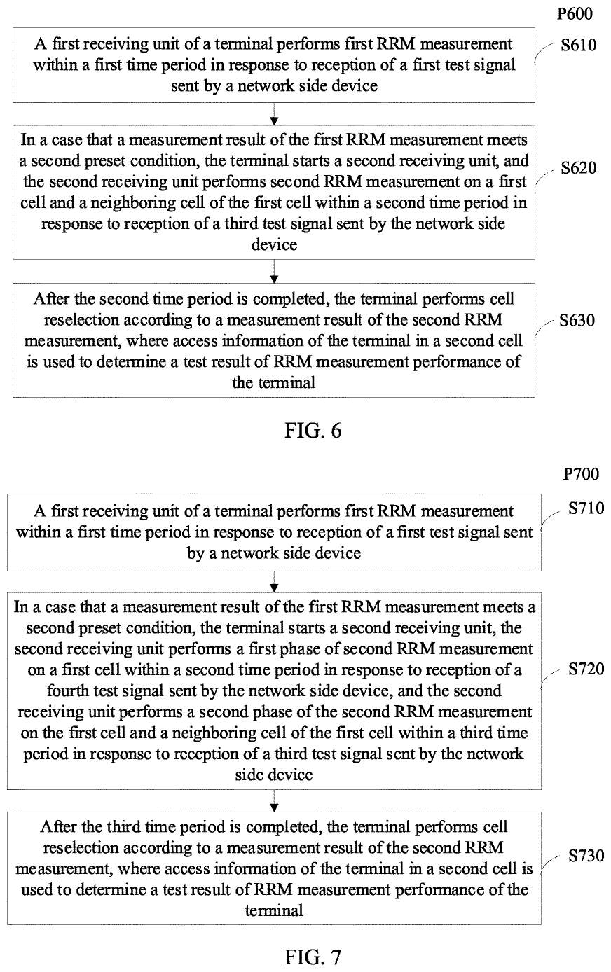

Based on Embodiment 1 and Embodiment 2, Embodiment 3 of this application provides an RRM measurement performance test method. The implementations described in Embodiment 1 and Embodiment 2 may be applied to Embodiment 3, and a same technical effect can be achieved. FIG. 6 is a flowchart of an RRM measurement performance test method P600 according to Embodiment 3 of this application. As shown in FIG. 6, the RRM measurement performance test method P600 provided in this embodiment includes the following steps.
S610. A first receiving unit of a terminal performs first RRM measurement within a first time period in response to reception of a first test signal sent by a network side device.

In this embodiment of this application, both the first time period and a second time period refer to time lengths for performing an RRM measurement performance test by the terminal, and have a time sequence relationship. Specific duration of the first time period and the second time period may be determined according to an actual requirement. This is not limited in this embodiment of this application.

In an exemplary embodiment, the first test signal may be at least one of the following information:
a preset number of LP-WUS signals;
a preset number of LP-SS signals;
an LP-SS signal with a fixed time window length; or
an LP-WUS signal with a fixed time window length.

Within the first time period, the first receiving unit (a low power receiver) of the terminal 110 is in a working state, and a second receiving unit (a primary receiver) is in a sleep state. Therefore, after the network side device (a test device) sends the first test information, the first receiving unit can detect the first test signal, and perform the first RRM measurement according to the detected first test signal.
S620. In a case that a measurement result of the first RRM measurement meets a second preset condition, the terminal starts a second receiving unit, and the second receiving unit performs second RRM measurement on a first cell and a neighboring cell of the first cell within a second time period in response to reception of a third test signal sent by the network side device.

This embodiment of this application is used to test a wake-up capability/wake-up behavior of the terminal for the second receiving unit. Therefore, the first test information in this embodiment of this application is a signal that represents poor signal quality of a current cell, so that it can be ensured that the measurement result of the first RRM measurement meets the second preset condition. Further, a condition for starting the second receiving unit can be met only when the measurement result of the first RRM measurement is that the network quality of the current cell is poor.

Specifically, the terminal (which may be specifically the first receiving unit) wakes up the second receiving unit in a case that the measurement result of the first RRM measurement is that the network quality of the current cell is poor. Further, the second receiving unit performs the second RRM measurement on the first cell and the neighboring cell of the first cell within the second time period, so as to implement cell reselection.

For example, the second receiving unit simultaneously performs the second RRM measurement on the first cell and the neighboring cell of the first cell according to the third test signal sent by the network side device. In a process of performing the second RRM measurement, the third test signal sent by the network side device needs to meet that network quality of at least one neighboring cell is greater than network signal quality of the first cell, so as to meet a test requirement for cell reselection.

In an exemplary embodiment, after the second receiving unit is waked up, the first receiving unit may be controlled to switch from a working state to a sleep state, so as to start energy saving.
S630. After the second time period is completed, the terminal performs cell reselection according to a measurement result of the second RRM measurement, where access information of the terminal in a second cell is used to determine a test result of RRM measurement performance of the terminal.

For example, after the second RRM measurement is completed within the second time period, the terminal performs cell reselection according to the measurement result of the second RRM measurement to camp on the second cell. Further, the access information of the terminal in the second cell is used to determine the test result of the RRM measurement performance of the terminal. A specific implementation in which the terminal 110 determines the measurement result of the RRM measurement is the same as the specific implementation of S530, and details are not described herein again.

In a test process provided in the method P600, a first receiving unit is in a startup state and a second receiving unit is in a sleep state within a first time period. In the first time period, the first receiving unit monitors first test information, and performs first RRM measurement on a current cell based on the first test signal. A measurement result of the first RRM measurement is that network quality of a first cell is poor, to ensure a condition for waking up the second receiving unit by the terminal. The second receiving unit simultaneously performs second RRM measurement on the first cell and a neighboring cell of the first cell within a second time period. The terminal performs cell reselection according to a measurement result of the second RRM measurement. After camping on a second cell, the terminal may determine a test result of RRM measurement performance of the terminal according to access information of the terminal in the second cell. It can be learned that this embodiment of this application can provide a performance test scheme for behavior that a low power receiver wakes up a primary receiver.

### Embodiment 4

Based on Embodiment 1 and Embodiment 2, Embodiment 4 of this application provides an RRM measurement performance test method. Implementations described in Embodiment 1 and Embodiment 2 may be applied to Embodiment 4, and a same technical effect can be achieved. FIG. 7 is a flowchart of an RRM measurement performance test method P700 according to Embodiment 3 of this application. As shown in FIG. 7, the RRM measurement performance test method P700 provided in this embodiment includes the following steps.
S710. A first receiving unit of a terminal performs first RRM measurement within a first time period in response to reception of a first test signal sent by a network side device.

In this embodiment of this application, the first time period, a second time period, and a third time period all refer to time lengths for performing an RRM measurement performance test by the terminal, and have a time sequence relationship. Specific duration of the first time period, the second time period, and the third time period may be determined according to an actual requirement. This is not limited in this embodiment of this application.

In an exemplary embodiment, the first test signal may be at least one of the following information:
a preset number of LP-WUS signals;
a preset number of LP-SS signals;
an LP-SS signal with a fixed time window length; or
an LP-WUS signal with a fixed time window length.

Within the first time period, the first receiving unit (a low power receiver) of the terminal 110 is in a working state, and a second receiving unit (a primary receiver) is in a sleep state. Therefore, after the network side device (a test device) sends the first test information, the first receiving unit can detect the first test signal, and perform the first RRM measurement according to the detected first test signal.
S720. In a case that a measurement result of the first RRM measurement meets a second preset condition, the terminal starts a second receiving unit, the second receiving unit performs a first phase of second RRM measurement on a first cell within a second time period in response to reception of a fourth test signal sent by the network side device, and the second receiving unit performs a second phase of the second RRM measurement on the first cell and a neighboring cell of the first cell within a third time period in response to reception of a third test signal sent by the network side device.

This embodiment of this application is used to test a wake-up capability/wake-up behavior of the terminal for the second receiving unit. Therefore, the first test information in this embodiment of this application is a signal that represents poor signal quality of a current cell, so that it can be ensured that the measurement result of the first RRM measurement meets the second preset condition. Further, a condition for starting the second receiving unit can be met only when the measurement result of the first RRM measurement is that the network quality of the current cell is poor.

Specifically, the terminal (which may be specifically the first receiving unit) wakes up the second receiving unit in a case that the measurement result of the first RRM measurement is that the network quality of the current cell is poor. Further, the second receiving unit performs the first phase of the second RRM measurement on the first cell within the second time period. Specifically, within the second time period, a test signal used when the second receiving unit performs the first phase of the second RRM measurement may be referred to as the fourth test signal, where the fourth test signal needs to meet that network signal quality of the first cell is greater than that of the neighboring cell. Through the first phase of the second RRM measurement performed by the second receiving unit, accuracy of the first RRM measurement performed by the first receiving unit in the first time period may be verified, to ensure accuracy of the measurement result of the RRM measurement by the terminal. In addition, for the second receiving unit that has just been started, performing the first phase of the second RRM measurement can serve as a warm-up effect. This helps ensure accuracy of subsequent measurement by the second receiving unit.

For example, in a case that it is verified, via a measurement result of the first phase of the second RRM measurement, that the network quality of the current cell is poor, the second receiving unit performs the second phase of the second RRM measurement on the first cell and the neighboring cell within the third time period, so as to implement cell reselection.

For example, the second receiving unit simultaneously performs the second phase of the second RRM measurement on the first cell and the neighboring cell of the first cell according to the third test signal sent by the network side device. In the second phase of the second RRM measurement, the third test signal sent by the network side device needs to meet that network quality of at least one neighboring cell is greater than the network signal quality of the first cell, so as to meet a test requirement for cell reselection.

In an exemplary embodiment, after the second receiving unit is waked up, the first receiving unit may be controlled to switch from a working state to a sleep state, so as to start energy saving.
S730. After the third time period is completed, the terminal performs cell reselection according to a measurement result of the second RRM measurement, where access information of the terminal in a second cell is used to determine a test result of RRM measurement performance of the terminal.

For example, after the second phase of the second RRM measurement is completed in the third time period, the terminal performs cell reselection according to a measurement result of the second phase of the second RRM measurement to camp on the second cell. Further, the access information of the terminal in the second cell is used to determine the test result of the RRM measurement performance of the terminal. A specific implementation in which the terminal 110 determines the measurement result of the RRM measurement is the same as the specific implementation of S530, and details are not described herein again.

In a test process provided in the method P700, a first receiving unit is in a startup state and a second receiving unit is in a sleep state within a first time period. In the first time period, the first receiving unit monitors first test information, and performs first RRM measurement on a current cell based on the first test signal. A measurement result of the first RRM measurement is that network quality of a first cell is poor, to ensure a condition for waking up the second receiving unit by the terminal. The second receiving unit performs a first phase of second RRM measurement on the first cell within a second time period, to verify a measurement result of the first receiving unit. The second receiving unit simultaneously performs a second phase of the second RRM measurement on the first cell and a neighboring cell of the first cell within a third time period. The terminal performs cell reselection according to a measurement result of the second phase of the second RRM measurement. After camping on a second cell, the terminal may determine a test result of RRM measurement performance of the terminal according to access information of the terminal in the second cell. It can be learned that this embodiment of this application can provide a performance test scheme for behavior that a low power receiver wakes up a primary receiver.

### Embodiment 5

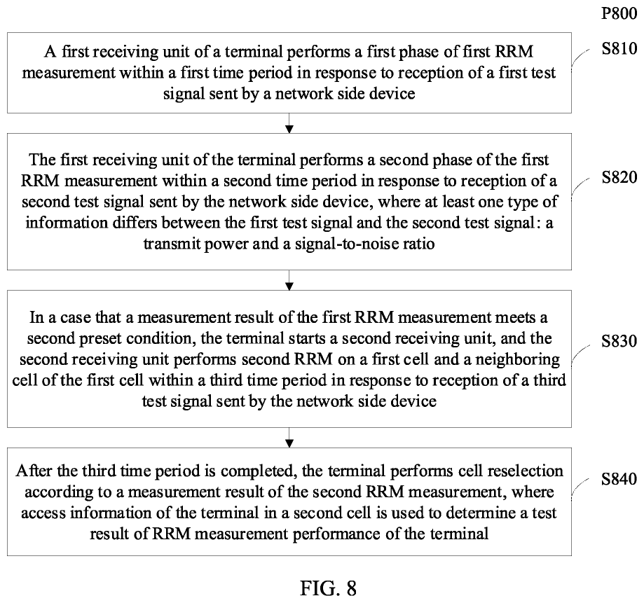

Based on Embodiment 1 and Embodiment 2, Embodiment 5 of this application provides an RRM measurement performance test method. Implementations described in Embodiment 1 may be applied to Embodiment 5, and a same technical effect can be achieved. FIG. 8 is a flowchart of an RRM measurement performance test method P800 according to Embodiment 5 of this application. As shown in FIG. 8, the RRM measurement performance test method P800 provided in this embodiment includes the following steps.
S810. A first receiving unit of a terminal performs a first phase of first RRM measurement within a first time period in response to reception of a first test signal sent by a network side device. S820. The first receiving unit of the terminal performs a second phase of the first RRM measurement within a second time period in response to reception of a second test signal sent by the network side device, where at least one type of information differs between the first test signal and the second test signal: a transmit power and a signal-to-noise ratio.

In this embodiment of this application, the first time period, a second time period, and a third time period all refer to time lengths for performing an RRM measurement performance test by the terminal, and have a time sequence relationship. Specific duration of the first time period, the second time period, and the third time period may be determined according to an actual requirement. This is not limited in this embodiment of this application.

In an exemplary embodiment, transmit powers of the first test signal and the second test signal are different, or signal-to-noise ratios between the foregoing two test signals are different, or both transmit powers and signal-to-noise ratios between the foregoing two test signals are different. For example, both the first test signal and the second test signal may be at least one of the following information:
a preset number of LP-WUS signals;
a preset number of LP-SS signals;
an LP-SS signal with a fixed time window length; or
an LP-WUS signal with a fixed time window length.

Within the first time period and the second time period, the first receiving unit (a low power receiver) of the terminal 110 is in a working state, and a second receiving unit (a primary receiver) is in a sleep state. Therefore, after the network side device (a test device) sends the first test information in the first time period, the first receiving unit can detect the first test signal, and perform the first phase of the first RRM measurement according to the detected first test signal. After the network side device (a test device) sends the second test information in the second time period, the first receiving unit can detect the second test signal, and perform the second phase of the first RRM measurement according to the detected second test signal.

This embodiment of this application is used to test a wake-up capability/wake-up behavior of the terminal for the second receiving unit. Therefore, the second test information in this embodiment of this application is a signal that represents poor signal quality of a current cell, so that it can be ensured that a test result of the second phase of the first RRM measurement meets the second preset condition. Further, a condition for starting the second receiving unit can be met only when a measurement result of the second phase of the first RRM measurement is that the network quality of the current cell is poor.

For example, the first phase of the first RRM measurement in this embodiment of this application may be used as a comparison of the second phase of the first RRM measurement. Therefore, the first test information is a signal that represents strong signal quality of the current cell, so that it can be ensured that the test result of the first phase of the first RRM measurement does not meet the second preset condition. Therefore, the second receiving unit is not waked up in the second time period, but the second receiving unit is waked up only when the measurement result of the second phase of the first RRM measurement is that the network quality of the current cell is poor.
S830. In a case that a measurement result of the first RRM measurement meets a second preset condition, the terminal starts a second receiving unit, and the second receiving unit performs second RRM measurement on a first cell and a neighboring cell of the first cell within a third time period in response to reception of a third test signal sent by the network side device.

Specifically, the terminal (which may be specifically the first receiving unit) wakes up the second receiving unit in a case that the measurement result of the second phase of the first RRM measurement is that the network quality of the current cell is poor. Further, the second receiving unit performs the second RRM measurement on the first cell and the neighboring cell of the first cell within the third time period, so as to implement cell reselection.

For example, the second receiving unit simultaneously performs the second RRM measurement on the first cell and the neighboring cell of the first cell according to the third test signal sent by the network side device. In a process of performing the second RRM measurement, the third test signal sent by the network side device needs to meet that network quality of at least one neighboring cell is greater than the network signal quality of the first cell, so as to meet a test requirement for cell reselection.

In an exemplary embodiment, after the second receiving unit is waked up, the first receiving unit may be controlled to switch from a working state to a sleep state, so as to start energy saving.
S840. After the third time period is completed, the terminal performs cell reselection according to a measurement result of the second RRM measurement, where access information of the terminal in a second cell is used to determine a test result of RRM measurement performance of the terminal.

For example, after the second RRM measurement is completed in the third time period, the terminal performs cell reselection according to the measurement result of the second RRM measurement to camp on the second cell. Further, the access information of the terminal in the second cell is used to determine the test result of the RRM measurement performance of the terminal. A specific implementation in which the terminal 110 determines the measurement result of the RRM measurement is the same as the specific implementation of S530, and details are not described herein again.

In a test process provided in the method P800, a first receiving unit is in a startup state and a second receiving unit is in a sleep state within a first time period and a second time period. In the first time period, the first receiving unit monitors first test information, and performs a first phase of first RRM measurement on a current cell based on the first test signal. In the second time period, the first receiving unit monitors second test information, and performs a second phase of the first RRM measurement on the current cell based on the second test signal. A measurement result of the second phase of the first RRM measurement is that network quality of a first cell is poor, to ensure a condition for waking up the second receiving unit by the terminal. The second receiving unit simultaneously performs second RRM measurement on the first cell and a neighboring cell of the first cell in a third time period. The terminal performs cell reselection according to a measurement result of the second RRM measurement. After camping on a second cell, the terminal determines a test result of RRM measurement performance of the terminal according to access information of the terminal in the second cell. It can be learned that this embodiment of this application can provide a performance test scheme for behavior that a low power receiver wakes up a primary receiver.

### Embodiment 6

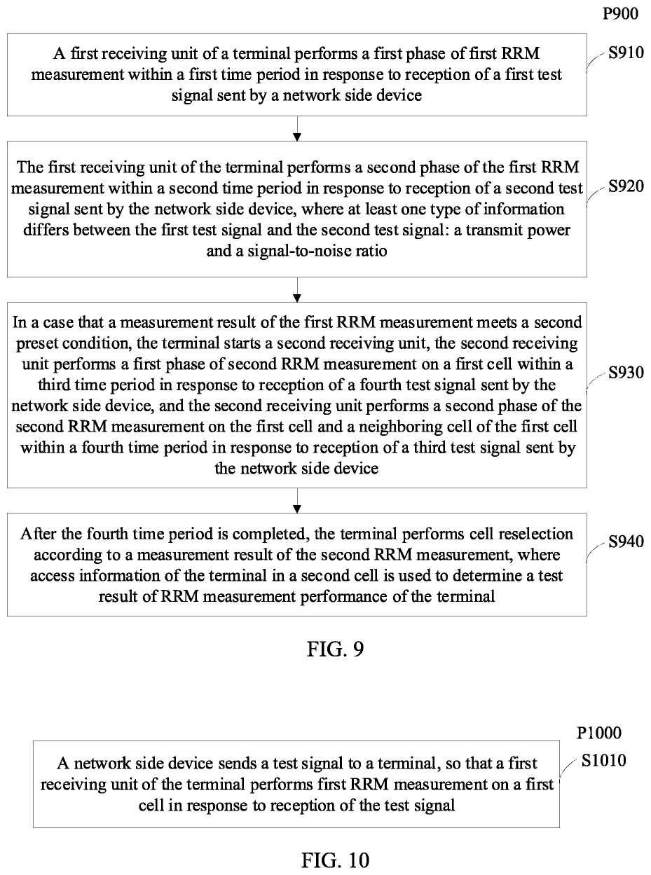

Based on Embodiment 1 and Embodiment 2, Embodiment 6 of this application provides an RRM measurement performance test method. Implementations described in Embodiment 1 and Embodiment 2 may be applied to Embodiment 6, and a same technical effect can be achieved. FIG. 9 is a flowchart of an RRM measurement performance test method P900 according to Embodiment 6 of this application. As shown in FIG. 9, the RRM measurement performance test method P900 provided in this embodiment includes the following steps.
S910. A first receiving unit of a terminal performs a first phase of first RRM measurement within a first time period in response to reception of a first test signal sent by a network side device. S920. The first receiving unit of the terminal performs a second phase of the first RRM measurement within a second time period in response to reception of a second test signal sent by the network side device, where at least one type of information differs between the first test signal and the second test signal: a transmit power and a signal-to-noise ratio.

In this embodiment of this application, the first time period, the second time period, a third time period, and a fourth time period all refer to time lengths for performing an RRM measurement performance test by the terminal, and have a time sequence relationship. Specific duration of the first time period, the second time period, the third time period, and the fourth time period may be determined according to an actual requirement. This is not limited in this embodiment of this application.

In an exemplary embodiment, transmit powers of the first test signal and the second test signal are different, or signal-to-noise ratios between the foregoing two test signals are different, or both transmit powers and signal-to-noise ratios between the foregoing two test signals are different. For example, both the first test signal and the second test signal may be at least one of the following information:
a preset number of LP-WUS signals;
a preset number of LP-SS signals;
an LP-SS signal with a fixed time window length; or
an LP-WUS signal with a fixed time window length.

Within the first time period and the second time period, the first receiving unit (a low power receiver) of the terminal 110 is in a working state, and a second receiving unit (a primary receiver) is in a sleep state. Therefore, after the network side device (a test device) sends the first test information in the first time period, the first receiving unit can detect the first test signal, and perform the first phase of the first RRM measurement according to the detected first test signal. After the network side device (a test device) sends the second test information in the second time period, the first receiving unit can detect the second test signal, and perform the second phase of the first RRM measurement according to the detected second test signal.

This embodiment of this application is used to test a wake-up capability/wake-up behavior of the terminal for the second receiving unit. Therefore, the second test information in this embodiment of this application is a signal that represents poor signal quality of a current cell, so that it can be ensured that a test result of the second phase of the first RRM measurement meets the second preset condition. Further, a condition for starting the second receiving unit can be met only when a measurement result of the second phase of the first RRM measurement is that the network quality of the current cell is poor.

For example, the first phase of the first RRM measurement in this embodiment of this application may be used as a comparison of the second phase of the first RRM measurement. Therefore, the first test information is a signal that represents strong signal quality of the current cell, so that it can be ensured that the test result of the first phase of the first RRM measurement does not meet the second preset condition. Therefore, the second receiving unit is not waked up in the second time period, but the second receiving unit is waked up only when the measurement result of the second phase of the first RRM measurement is that the network quality of the current cell is poor.
S930. In a case that a measurement result of the first RRM measurement meets a second preset condition, the terminal starts a second receiving unit, the second receiving unit performs a first phase of second RRM measurement on a first cell within a third time period in response to reception of a fourth test signal sent by the network side device, and the second receiving unit performs a second phase of the second RRM measurement on the first cell and a neighboring cell of the first cell within a fourth time period in response to reception of a third test signal sent by the network side device.

The terminal (which may be specifically the first receiving unit) wakes up the second receiving unit in a case that the measurement result of the second phase of the first RRM measurement is that the network quality of the current cell is poor. Further, the second receiving unit performs the first phase of the second RRM measurement on the first cell within the third time period. Specifically, in the third time period, a test signal used when the second receiving unit performs the first phase of the second RRM measurement may be referred to as the fourth test signal, and the fourth test signal needs to meet that the network signal quality of the first cell is greater than that of the neighboring cell. Through the first phase of the second RRM measurement performed by the second receiving unit, accuracy of the second phase of the first RRM measurement performed by the first receiving unit in the second time period may be verified, to ensure accuracy of the measurement result of the RRM measurement by the terminal. In addition, for the second receiving unit that has just been started, performing the first phase of the second RRM measurement can serve as a warm-up effect. This helps ensure accuracy of subsequent measurement by the second receiving unit.

For example, in a case that it is verified, via a measurement result of the first phase of the second RRM measurement, that the network quality of the current cell is poor, the second receiving unit performs the second phase of the second RRM measurement on the first cell and the neighboring cell of the first cell within the fourth time period, so as to implement cell reselection.

For example, the second receiving unit simultaneously performs the second phase of the second RRM measurement on the first cell and the neighboring cell of the first cell according to the test signal sent by the network side device. In the second phase of the second RRM measurement, the third test signal sent by the network side device needs to meet that network quality of a neighboring cell of at least one first cell is greater than network signal quality of the first cell, so as to meet a test requirement for cell reselection.

In an exemplary embodiment, after the second receiving unit is waked up, the first receiving unit may be controlled to switch from a working state to a sleep state, so as to start energy saving.
S940. After the fourth time period is completed, the terminal performs cell reselection according to a measurement result of the second RRM measurement, where access information of the terminal in a second cell is used to determine a test result of RRM measurement performance of the terminal.

For example, after the second phase of the second RRM measurement is completed in the fourth time period, the terminal performs cell reselection according to a measurement result of the second phase of the second RRM measurement, and camps on the second cell. Further, the access information of the terminal in the second cell is used to determine the test result of the RRM measurement performance of the terminal. A specific implementation in which the terminal 110 determines the measurement result of the RRM measurement is the same as the specific implementation of S530, and details are not described herein again.

In a test process provided in the method P900, a first receiving unit is in a startup state and a second receiving unit is in a sleep state within a first time period and a second time period. In the first time period, the first receiving unit monitors first test information, and performs a first phase of first RRM measurement on a current cell based on the first test signal. In the second time period, the first receiving unit monitors second test information, and performs a second phase of the first RRM measurement on the current cell based on the second test signal. A measurement result of the second phase of the first RRM measurement is that network quality of a first cell is poor, to ensure a condition for waking up the second receiving unit by the terminal. The second receiving unit performs a first phase of second RRM measurement on the first cell in a third time period, to verify a measurement result of the first receiving unit. The second receiving unit simultaneously performs a second phase of the second RRM measurement on the first cell and a neighboring cell of the first cell in a fourth time period. The terminal performs cell reselection according to a measurement result of the second phase of the second RRM measurement. After camping on a second cell, the terminal determines a test result of RRM measurement performance of the terminal according to access information of the terminal in the second cell. It can be learned that this embodiment of this application can provide a performance test scheme for behavior that a low power receiver wakes up a primary receiver.

### Embodiment 7

Embodiment 6 of this application provides an RRM measurement performance test method, and is executed by a network side device. FIG. 10 is a flowchart of an RRM measurement performance test method P1000 according to Embodiment 7 of this application. As shown in FIG. 10, the RRM measurement performance test method P1000 provided in this embodiment includes the following steps.
S1010. A network side device sends a test signal to a terminal, so that a first receiving unit of the terminal performs first RRM measurement on a first cell in response to reception of the test signal, where an operating power of the first receiving unit meets a first preset condition.

In an exemplary embodiment, the network side device may be a test device. A type of the signal that is sent by the network side device and that is used by the first receiving unit to perform the first RRM measurement includes at least one of the following: a low power wake-up signal LP-WUS or a Low Power Synchronization Signal (LP-SS). For example, the LP-WUS may be an on-off keying (on-off keying) signal. FIG. 4 shows a time domain pattern in which the test signal used by the first receiving unit in the first RRM measurement process is an LP-WUS. It can be understood that the type of the test signal used by the first receiving unit in the first RRM measurement process is not limited to the foregoing, and may be another type. This is not limited in this embodiment of this application.

For example, the test signal (including a “first test signal” and a “second test signal” in the following embodiments) is a signal used by the first receiving unit to perform the first RRM measurement, and may be specifically a signal with a specific test parameter, or may be a signal with a random parameter determined according to an actual scenario. This is not limited in this embodiment of this application.

For example, the test signal may be received by a low power receiver in the terminal by means of energy detection, sequence detection identification, or payload detection.

In an exemplary embodiment, as shown in FIG. 2, the terminal may be deployed with the first receiving unit serving as a low power receiver and a second receiving unit serving as a primary receiver. As described above, the first receiving unit serving as a low power receiver does not perform signal detection (for example, amplification, filtering, and quantization) of a Radio Frequency (RF) module, complex baseband (MODEM) signal handling, and the like, but only performs passive matching filtering and signal processing with low power consumption. The operating power of the first receiving unit is less than a preset value, and the first receiving unit may be referred to as an almost “zero” receiver.

In an exemplary embodiment, the terminal is in a Radio Resource Control (RRC) idle mode or an RRC inactivate mode. For example, the first cell may be a cell in which the terminal 110 currently accesses or is located. To simplify description, the cell may also be referred to as this cell or a current cell of the terminal 110. For example, for the terminal 110 in an RRC idle mode or an RRC inactivate mode, the cell is a cell on which the terminal 110 camps. For another example, for a terminal in an RRC connected state, this cell is a serving cell of the terminal 110.

For example, in a case that the first receiving unit (a low power receiver) receives the test signal, RRM performance measurement may be performed by using the received test signal. For example, in a case that the received test signal is an LP-SS, at least one of Reference Signal Received Power (RSRP) measurement, Reference Signal Received Quality (RSRQ) measurement, Signal to Interference plus Noise Ratio (SINR) measurement, or Receive Signal Strength Indication (RSSI) measurement is performed.

It should be noted that, in a process in which the first receiving unit (a low power receiver) performs the first RRM measurement on the first cell, the second receiving unit (a primary receiver) is in a power-off state or a sleep state to maintain low power consumption, thereby implementing power saving by receiving a wake-up signal. Therefore, radio frequency transmit/receive processing and baseband processing by the second receiving unit (a primary receiver) can be avoided or reduced, thereby implementing energy saving of the terminal.

In an exemplary embodiment, in a case that a measurement result of the first RRM measurement meets a second preset condition, the terminal starts a second receiving unit, and performs second RRM measurement by using the second receiving unit so as to perform cell reselection.

In an exemplary embodiment, the second preset condition may be that the result of the first RRM measurement reaches a preset threshold or a preset threshold range. If the measurement result of the first RRM measurement meets the second preset condition, it indicates that current network quality is poor, and the second receiving unit (a primary receiver) needs to be waked up so as to perform cell reselection.

For example, the result of the first RRM measurement may be represented by at least one of an RSRP, an RSRQ, an SINR, or an RSSI. A corresponding threshold may be defined for each measurement result. When at least one measurement result meets a corresponding threshold or threshold range, the terminal 110 needs to wake up the second receiving unit (a primary receiver) so as to perform cell reselection.

In an exemplary embodiment, the network side device 120 sends the test signal (denoted as a “third test signal”), so that the terminal 110 simultaneously performs the second RRM measurement on the first cell and a neighboring cell (intra-frequency or inter-frequency) of the first cell. In the second RRM measurement process, the third test signal sent by the network side device needs to meet that network quality of at least one neighboring cell is greater than the network signal quality of the first cell, so as to meet a test requirement for cell reselection.

Further, the access information of the terminal 110 in the second cell is used to determine the test result of the RRM measurement performance of the terminal. For example, the test result may be determined by the terminal 110, or may be determined by the network side device 120 serving as a test device, thereby improving test flexibility. Embodiments of this application are separately described in the following embodiments.

In the scheme provided in the method P1000, a first receiving unit of a terminal is in a startup phase to monitor a test signal sent by a network side device, and a second receiving unit is in a sleep state. The first receiving unit performs first RRM measurement on a first cell in a case that the test signal sent by the network side to the terminal is detected. In a case that a measurement result of the first RRM measurement meets a second preset condition, the terminal starts the second receiving unit, and performs second RRM measurement by using the second receiving unit so as to perform cell reselection. Further, access information of the terminal in a second cell may be used to determine a test result of RRM measurement performance of the terminal. For example, that the terminal successfully accesses the second cell indicates that the first receiving unit successfully wakes up the second receiving unit in the RRM measurement process. It can be learned that this embodiment of this application can provide a performance test scheme for behavior that a low power receiver wakes up a primary receiver.

### Embodiment 8

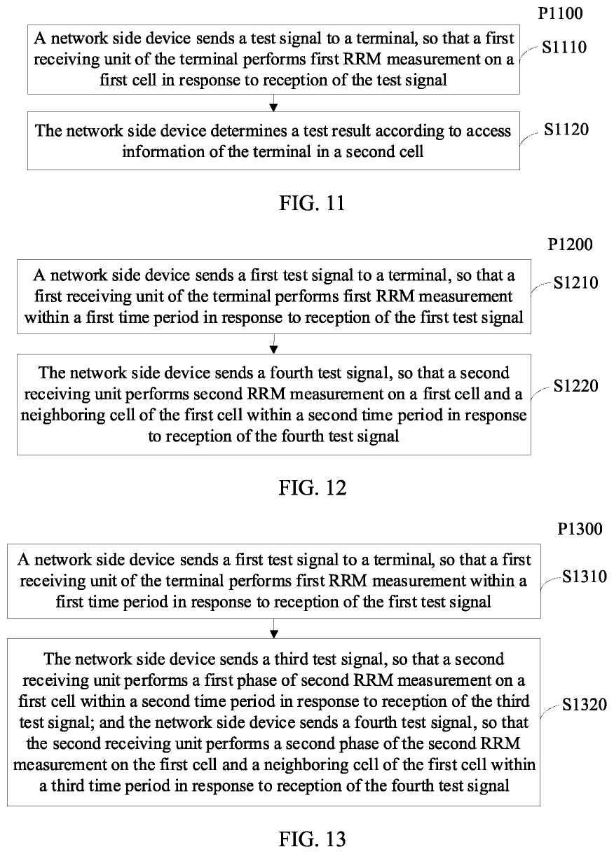

Based on Embodiment 7, Embodiment 8 of this application provides an RRM measurement performance test method. Implementations described in Embodiment 7 may be applied to Embodiment 8, and a same technical effect can be achieved. FIG. 11 is a flowchart of an RRM measurement performance test method P1100 according to Embodiment 8 of this application. As shown in FIG. 11, the RRM measurement performance test method P1100 provided in this embodiment includes the following steps.
S1110. A network side device sends a test signal to a terminal, so that a first receiving unit of the terminal performs first RRM measurement on a first cell in response to reception of the test signal, where an operating power of the first receiving unit meets a first preset condition.

In a case that a measurement result of the first RRM measurement meets a second preset condition, the terminal starts a second receiving unit, and performs second RRM measurement by using the second receiving unit so as to perform cell reselection, where access information of the terminal in a second cell is used to determine a test result of RRM measurement performance of the terminal.

A specific implementation of S1110 is the same as the specific implementation of S1010, and details are not described herein again.
S1120. The network side device determines a test result according to access information of the terminal in a second cell.

As described above, the second cell is a neighboring cell of the first cell. The first receiving unit of the terminal 110 wakes up the second receiving unit of the terminal 110 when determining that network quality of the first cell is poor. The second receiving unit executes the second RRM strategy to perform cell reselection and access a network of the second cell. Further, after the terminal 110 camps on the second cell, the test result is determined according to the access information of the terminal 110 in the second cell.
S1120-1. After the terminal 110 camps on the second cell, the network side device 120 obtains a number of accesses on a Random Access Channel (RACH) initiated by the second receiving unit within preset duration. An RACH is an uplink transmission channel, and is a first message sent by UE to an eNB when the terminal 110 is started. In all cellular technologies (CDMA, GSM, WCDMA, and LTE), a signal similar to the RACH is used as the first message sent by the UE to the eNB, and this message is applicable to the embodiments of this application.
S1120-2. Determine a test result of RRM measurement performance of the terminal according to the number of accesses.

For example, if the number of accesses on the RACH of the terminal within the preset duration is less than a preset number of times, it indicates that the terminal 110 successfully accesses the second cell. Therefore, it is proved that the first receiving unit of the terminal successfully wakes up the second receiving unit after determining that the second RRM is performed on the first cell. It can be learned that this embodiment of this application can provide a performance test scheme for behavior that a low power receiver wakes up a primary receiver.

### Embodiment 9

Based on Embodiment 7 and Embodiment 8, Embodiment 9 of this application provides an RRM measurement performance test method. Implementations described in Embodiment 7 and Embodiment 8 may be applied to Embodiment 9, and a same technical effect can be achieved. FIG. 12 is a flowchart of an RRM measurement performance test method P1200 according to Embodiment 9 of this application. As shown in FIG. 12, the RRM measurement performance test method P1200 provided in this embodiment includes the following steps.
S1210. A network side device sends a first test signal to a terminal, so that a first receiving unit of the terminal performs first RRM measurement within a first time period in response to reception of the first test signal.

In an exemplary embodiment, the first test signal may be at least one of the following information:
a preset number of LP-WUS signals;
a preset number of LP-SS signals;
an LP-SS signal with a fixed time window length; or
an LP-WUS signal with a fixed time window length.

Within the first time period, the first receiving unit (a low power receiver) of the terminal 110 is in a working state, and a second receiving unit (a primary receiver) is in a sleep state. Therefore, after the network side device (a test device) sends the first test information, the first receiving unit can detect the first test signal, and perform the first RRM measurement according to the detected first test signal.

This embodiment of this application is used to test a wake-up capability/wake-up behavior of the terminal for the second receiving unit. Therefore, the first test information in this embodiment of this application is a signal that represents poor signal quality of a current cell, so that it can be ensured that the measurement result of the first RRM measurement meets the second preset condition. Further, a condition for starting the second receiving unit can be met only when the measurement result of the first RRM measurement is that the network quality of the current cell is poor.

Based on the first test signal sent by the network side, the terminal may execute the following two embodiments, to implement a measurement process of the RRM measurement by the terminal.
S1220. The network side device sends a third test signal, so that a second receiving unit performs second RRM measurement on a first cell and a neighboring cell of the first cell within a second time period in response to reception of the third test signal.

In a case that the measurement result of the first RRM measurement meets the second preset condition, the terminal starts the second receiving unit; and the network side device continues to send a test signal, so that the second receiving unit performs the second RRM measurement on the first cell and the neighboring cell of the first cell within the second time period.

In this embodiment of this application, both the first time period and a second time period refer to time lengths for performing an RRM measurement performance test by the terminal, and have a time sequence relationship. Specific duration of the first time period and the second time period may be determined according to an actual requirement. This is not limited in this embodiment of this application.

Specifically, the terminal (which may be specifically the first receiving unit) wakes up the second receiving unit in a case that the measurement result of the first RRM measurement is that the network quality of the current cell is poor. Further, the second receiving unit performs the second RRM measurement on the first cell and the neighboring cell of the first cell within the second time period, so as to implement cell reselection.

In an exemplary embodiment, the network side device 120 sends the test signal, so that the terminal 110 simultaneously performs the second RRM measurement on the first cell and the neighboring cell of the first cell. In the second RRM measurement process, the third test signal sent by the network side device needs to meet that network quality of a neighboring cell of at least one first cell is greater than the network signal quality of the first cell, so as to meet a test requirement for cell reselection.

In an exemplary embodiment, after the second receiving unit of the terminal 110 is waked up, the first receiving unit may be controlled to switch from a working state to a sleep state, so as to start energy saving.

In an exemplary embodiment, after completing the second RRM measurement, the terminal 110 performs cell reselection according to a measurement result of the second RRM measurement to camp on the second cell. Further, access information of the network side device 120 in the second cell is used to determine a test result of RRM measurement performance of the terminal. A specific implementation in which the network side device 120 determines the measurement result of the RRM measurement is the same as the specific implementation of S1120, and details are not described herein again.

In a test process provided in the method P1200, a first receiving unit is in a startup state and a second receiving unit is in a sleep state within a first time period. In the first time period, the network side device sends first test information. The first receiving unit of the terminal monitors the first test information, and performs first RRM measurement on a current cell based on the first test signal. A measurement result of the first RRM measurement is that network quality of a first cell is poor, to ensure a condition for waking up the second receiving unit by the terminal. Then, the network side device sends a test signal, so that the second receiving unit simultaneously performs second RRM measurement on the first cell and a neighboring cell of the first cell. The terminal performs cell reselection according to a measurement result of the second RRM measurement. After a second cell is camped on, the network side device determines a test result of RRM measurement performance of the terminal according to access information of the terminal in the second cell. It can be learned that this embodiment of this application can provide a performance test scheme for behavior that a low power receiver wakes up a primary receiver.

### Embodiment 10

Based on Embodiment 7 and Embodiment 8, Embodiment 10 of this application provides an RRM measurement performance test method. Implementations described in Embodiment 7 and Embodiment 8 may be applied to Embodiment 10, and a same technical effect can be achieved. FIG. 13 is a flowchart of an RRM measurement performance test method P1300 according to Embodiment 10 of this application. As shown in FIG. 13, the RRM measurement performance test method P1300 provided in this embodiment includes the following steps.
S1310. A network side device sends a first test signal to a terminal, so that a first receiving unit of the terminal performs first RRM measurement within a first time period in response to reception of the first test signal.

A specific implementation of S1310 is the same as the specific implementation of S1210, and details are not described herein again.
S1320. The network side device sends a fourth test signal, so that a second receiving unit performs a first phase of second RRM measurement on a first cell within a second time period in response to reception of the fourth test signal; and the network side device sends a third test signal, so that the second receiving unit performs a second phase of the second RRM measurement on the first cell and a neighboring cell of the first cell within a third time period in response to reception of the third test signal.

In a case that a measurement result of the first RRM measurement meets a second preset condition, the terminal starts the second receiving unit; and the network side device continues to send a test signal, so that the second receiving unit performs the first phase of the second RRM measurement on the first cell within the second time period, and performs the second phase of the second RRM measurement on the first cell and the neighboring cell of the first cell by using the second receiving unit within the third time period.

In this embodiment of this application, the first time period, a second time period, and a third time period all refer to time lengths for performing an RRM measurement performance test by the terminal, and have a time sequence relationship. Specific duration of the first time period, the second time period, and the third time period may be determined according to an actual requirement. This is not limited in this embodiment of this application.

Specifically, the terminal (which may be specifically the first receiving unit) wakes up the second receiving unit in a case that the measurement result of the first RRM measurement is that network quality of a current cell is poor. Further, the second receiving unit performs the first phase of the second RRM measurement on the first cell within the second time period. Specifically, in the second time period, a test signal used when the second receiving unit performs the second RRM measurement may be the same as the first test signal. Through the first phase of the second RRM measurement performed by the second receiving unit, accuracy of the first RRM measurement performed by the first receiving unit in the first time period may be verified, to ensure accuracy of the measurement result of the RRM measurement by the terminal. In addition, for the second receiving unit that has just been started, performing the first phase of the second RRM measurement can serve as a warm-up effect. This helps ensure accuracy of subsequent measurement by the second receiving unit.

For example, in a case that it is verified, via a measurement result of the first phase of the second RRM measurement, that the network quality of the current cell is poor, the second receiving unit performs the second phase of the second RRM measurement on the first cell and the neighboring cell of the first cell within the third time period, so as to implement cell reselection.

For example, the second receiving unit simultaneously performs the second phase of the second RRM measurement on the first cell and the neighboring cell of the first cell according to the test signal sent by the network side device. In the second phase of the second RRM measurement, the third test signal sent by the network side device needs to meet that network quality of a neighboring cell of at least one first cell is greater than network signal quality of the first cell, so as to meet a test requirement for cell reselection.

In an exemplary embodiment, after the second receiving unit of the terminal 110 is waked up, the first receiving unit may be controlled to switch from a working state to a sleep state, so as to start energy saving.

In an exemplary embodiment, after completing the second RRM measurement, the terminal 110 performs cell reselection according to a measurement result of the second RRM measurement to camp on the second cell. Further, access information of the network side device 120 in the second cell is used to determine a test result of RRM measurement performance of the terminal. A specific implementation in which the network side device 120 determines the measurement result of the RRM measurement is the same as the specific implementation of S1120, and details are not described herein again.

In a test process provided in the method P1300, a first receiving unit is in a startup state and a second receiving unit is in a sleep state within a first time period. In the first time period, the network side device sends first test information. The first receiving unit of the terminal monitors the first test information, and performs first RRM measurement on a current cell based on the first test signal. A measurement result of the first RRM measurement is that network quality of a first cell is poor, to ensure a condition for waking up the second receiving unit by the terminal. Then, the network side device first performs RRM measurement on the first cell and then simultaneously performs RRM measurement on the first cell and the neighboring cell of the first cell. The terminal performs cell reselection according to a measurement result of second RRM measurement. After a second cell is camped on, the network side device determines a test result of RRM measurement performance of the terminal according to access information of the terminal in the second cell. It can be learned that this embodiment of this application can provide a performance test scheme for behavior that a low power receiver wakes up a primary receiver.

### Embodiment 11

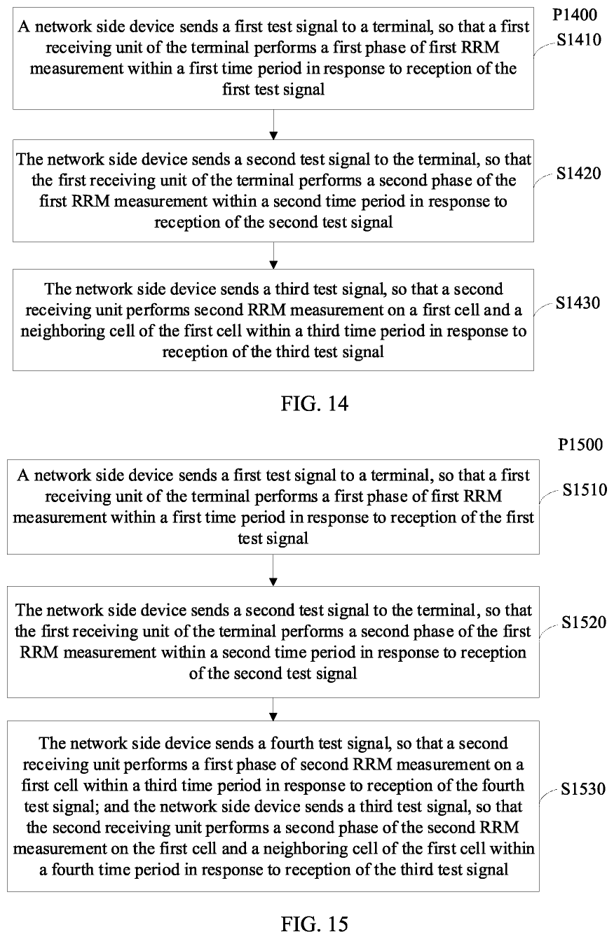

Based on Embodiment 7 and Embodiment 8, Embodiment 11 of this application provides an RRM measurement performance test method. Implementations described in Embodiment 7 and Embodiment 8 may be applied to Embodiment 11, and a same technical effect can be achieved. FIG. 14 is a flowchart of an RRM measurement performance test method P1400 according to Embodiment 11 of this application. As shown in FIG. 14, the RRM measurement performance test method P1400 provided in this embodiment includes the following steps.
S1410. A network side device sends a first test signal to a terminal, so that a first receiving unit of the terminal performs a first phase of first RRM measurement within a first time period in response to reception of the first test signal. S1420. The network side device sends a second test signal to the terminal, so that the first receiving unit of the terminal performs a second phase of the first RRM measurement within a second time period in response to reception of the second test signal.

In an exemplary embodiment, transmit powers of the first test signal and the second test signal are different, or signal-to-noise ratios between the foregoing two test signals are different, or both transmit powers and signal-to-noise ratios between the foregoing two test signals are different. For example, both the first test signal and the second test signal may be at least one of the following information:
a preset number of LP-WUS signals;
a preset number of LP-SS signals;
an LP-SS signal with a fixed time window length; or
an LP-WUS signal with a fixed time window length.

Within the first time period and the second time period, the first receiving unit (a low power receiver) of the terminal 110 is in a working state, and a second receiving unit (a primary receiver) is in a sleep state. Therefore, after the network side device (a test device) sends the first test information in the first time period, the first receiving unit can detect the first test signal, and perform the first phase of the first RRM measurement according to the detected first test signal. After the network side device (a test device) sends the second test information in the second time period, the first receiving unit can detect the second test signal, and perform the second phase of the first RRM measurement according to the detected second test signal.

This embodiment of this application is used to test a wake-up capability/wake-up behavior of the terminal for the second receiving unit. Therefore, the second test information in this embodiment of this application is a signal that represents poor signal quality of a current cell, so that it can be ensured that a test result of the second phase of the first RRM measurement meets the second preset condition. Further, a condition for starting the second receiving unit can be met only when a measurement result of the second phase of the first RRM measurement is that the network quality of the current cell is poor.

For example, the first phase of the first RRM measurement in this embodiment of this application may be used as a comparison of the second phase of the first RRM measurement. Therefore, the first test information is a signal that represents strong signal quality of the current cell, so that it can be ensured that the test result of the first phase of the first RRM measurement does not meet the second preset condition. Therefore, the second receiving unit is not waked up in the second time period, but the second receiving unit is waked up only when the measurement result of the second phase of the first RRM measurement is that the network quality of the current cell is poor.

Based on the first test signal and the second test signal sent by the network side, the terminal may execute the following two embodiments, to implement a measurement process of the RRM measurement by the terminal.
S1430. The network side device sends a third test signal, so that a second receiving unit performs second RRM measurement on a first cell and a neighboring cell of the first cell within a third time period in response to reception of the third test signal.

In a case that the measurement result of the first RRM measurement meets the second preset condition, the terminal starts the second receiving unit; and the network side device continues to send a test signal, so that the second receiving unit performs the second RRM measurement on the first cell and the neighboring cell of the first cell within the third time period based on the test signal.

Specifically, the terminal (which may be specifically the first receiving unit) wakes up the second receiving unit in a case that the measurement result of the second phase of the first RRM measurement is that the network quality of the current cell is poor. Further, the second receiving unit performs the second RRM measurement on the first cell and the neighboring cell of the first cell within the third time period, so as to implement cell reselection.

For example, the second receiving unit simultaneously performs the second RRM measurement on the first cell and the neighboring cell of the first cell according to the test signal sent by the network side device. In the second RRM measurement process, the third test signal sent by the network side device needs to meet that network quality of a neighboring cell of at least one first cell is greater than the network signal quality of the first cell, so as to meet a test requirement for cell reselection.

In an exemplary embodiment, after the second receiving unit is waked up, the first receiving unit may be controlled to switch from a working state to a sleep state, so as to start energy saving.

In an exemplary embodiment, after completing the second RRM measurement, the terminal 110 performs cell reselection according to a measurement result of the second RRM measurement to camp on the second cell. Further, access information of the network side device 120 in the second cell is used to determine a test result of RRM measurement performance of the terminal. A specific implementation in which the network side device 120 determines the measurement result of the RRM measurement is the same as the specific implementation of S1120, and details are not described herein again.

In a test process provided in the method P1400, a first receiving unit is in a startup state and a second receiving unit is in a sleep state within a first time period and a second time period. In the first time period, a network side device sends a first test signal, and the first receiving unit monitors the first test information, and performs a first phase of first RRM measurement on a current cell based on the first test signal. In the second time period, the network side device sends a second test signal, and the first receiving unit monitors the second test information, and performs a second phase of the first RRM measurement on the current cell based on the second test signal. A measurement result of the second phase of the first RRM measurement is that network quality of a first cell is poor, to ensure a condition for waking up the second receiving unit by the terminal. Then, the network side device continues to send a test signal, so that the second receiving unit of the terminal simultaneously performs a second phase of second RRM measurement on the first cell and a neighboring cell of the first cell. The terminal performs cell reselection according to a result of the second RRM measurement. After a second cell is camped on, the network side device determines a test result of RRM measurement performance of the terminal according to access information of the terminal in the second cell. It can be learned that this embodiment of this application can provide a performance test scheme for behavior that a low power receiver wakes up a primary receiver.

### Embodiment 12

Based on Embodiment 7 and Embodiment 8, Embodiment 12 of this application provides an RRM measurement performance test method. Implementations described in Embodiment 7 and Embodiment 8 may be applied to Embodiment 12, and a same technical effect can be achieved. FIG. 15 is a flowchart of an RRM measurement performance test method P1500 according to Embodiment 12 of this application. As shown in FIG. 15, the RRM measurement performance test method P1500 provided in this embodiment includes the following steps.
S1510. A network side device sends a first test signal to a terminal, so that a first receiving unit of the terminal performs a first phase of first RRM measurement within a first time period in response to reception of the first test signal. S1520. The network side device sends a second test signal to the terminal, so that the first receiving unit of the terminal performs a second phase of the first RRM measurement within a second time period in response to reception of the second test signal, where at least one type of information differs between the first test signal and the second test signal: a transmit power and a signal-to-noise ratio.

Specific implementations of S1510 and S1520 are the same as the specific implementations of S1410 and S1420, and details are not described herein again.
S1530. The network side device sends a fourth test signal, so that a second receiving unit performs a first phase of second RRM measurement on a first cell within a third time period in response to reception of the fourth test signal; and the network side device sends a third test signal, so that the second receiving unit performs a second phase of the second RRM measurement on the first cell and a neighboring cell of the first cell within a fourth time period in response to reception of the third test signal.

In a case that a measurement result of the first RRM measurement meets a second preset condition, the terminal starts the second receiving unit; and the network side device continues to send a test signal, so that the second receiving unit performs the first phase of the second RRM measurement on the first cell within the third time period, and the second receiving unit performs the second phase of the second RRM measurement on the first cell and the neighboring cell of the first cell within the fourth time period.

The terminal (which may be specifically the first receiving unit) wakes up the second receiving unit in a case that a measurement result of the second phase of the first RRM measurement is that network quality of a current cell is poor. Further, the second receiving unit performs the first phase of the second RRM measurement on the first cell within the third time period. Specifically, in the third time period, a test signal used when the second receiving unit performs the second RRM measurement may be the same as the second test signal. Through the first phase of the second RRM measurement performed by the second receiving unit, accuracy of the second phase of the first RRM measurement performed by the first receiving unit in the second time period may be verified, to ensure accuracy of the measurement result of the RRM measurement by the terminal. In addition, for the second receiving unit that has just been started, performing the first phase of the second RRM measurement can serve as a warm-up effect. This helps ensure accuracy of subsequent measurement by the second receiving unit.

For example, in a case that it is verified, via a measurement result of the first phase of the second RRM measurement, that the network quality of the current cell is poor, the second receiving unit performs the second phase of the second RRM measurement on the first cell and the neighboring cell of the first cell within the fourth time period, so as to implement cell reselection.

For example, the second receiving unit simultaneously performs the second phase of the second RRM measurement on the first cell and the neighboring cell of the first cell according to the test signal sent by the network side device. In the second phase of the second RRM measurement, the third test signal sent by the network side device needs to meet that network quality of a neighboring cell of at least one first cell is greater than network signal quality of the first cell, so as to meet a test requirement for cell reselection.

In an exemplary embodiment, after the second receiving unit is waked up, the first receiving unit may be controlled to switch from a working state to a sleep state, so as to start energy saving.

In an exemplary embodiment, after completing the second RRM measurement, the terminal 110 performs cell reselection according to a measurement result of the second RRM measurement to camp on the second cell. Further, access information of the network side device 120 in the second cell is used to determine a test result of RRM measurement performance of the terminal. A specific implementation in which the network side device 120 determines the measurement result of the RRM measurement is the same as the specific implementation of S1120, and details are not described herein again.

In a test process provided in the method P1500, a first receiving unit is in a startup state and a second receiving unit is in a sleep state within a first time period and a second time period. In the first time period, a network side device sends a first test signal, and the first receiving unit monitors the first test information, and performs a first phase of first RRM measurement on a current cell based on the first test signal. In the second time period, the network side device sends a second test signal, and the first receiving unit monitors the second test information, and performs a second phase of the first RRM measurement on the current cell based on the second test signal. A measurement result of the second phase of the first RRM measurement is that network quality of a first cell is poor, to ensure a condition for waking up the second receiving unit by the terminal. Then, the network side device continues to send a test signal, so that the second receiving unit of the terminal first performs RRM measurement on the first cell and then simultaneously performs RRM measurement on the first cell and the neighboring cell of the first cell. The terminal performs cell reselection according to a result of the second RRM measurement. After a second cell is camped on, the network side device determines a test result of RRM measurement performance of the terminal according to access information of the terminal in the second cell. It can be learned that this embodiment of this application can provide a performance test scheme for behavior that a low power receiver wakes up a primary receiver.

### Embodiment 13

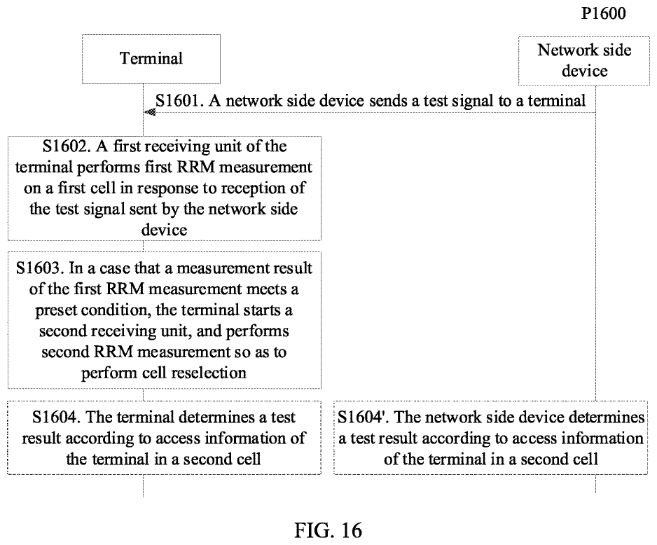

Based on the foregoing embodiment, Embodiment 13 of this application provides an RRM measurement performance test method. This embodiment is used to describe signaling interaction between a terminal and a network side device in a positioning process. FIG. 16 is a signaling flowchart of an RRM measurement performance test method P1600 according to Embodiment 13 of this application. As shown in FIG. 16, the RRM measurement performance test method P1400 provided in this embodiment includes the following steps.
S1601. A network side device sends a test signal to a terminal.
S1602. A first receiving unit of the terminal performs first RRM measurement on a first cell in response to reception of the test signal sent by the network side device.
S1603. In a case that a measurement result of the first RRM measurement meets a second preset condition, the terminal starts a second receiving unit, and performs second RRM measurement by using the second receiving unit so as to perform cell reselection.
S1604. The terminal determines a test result according to access information of the terminal in a second cell; or S1604′. The network side device determines a test result according to access information of the terminal in a second cell.

A specific implementation of the embodiment provided in the method P1400 is the same as the specific implementation of the method P300 or the method P1000, and details are not described herein again.

### Embodiment 14

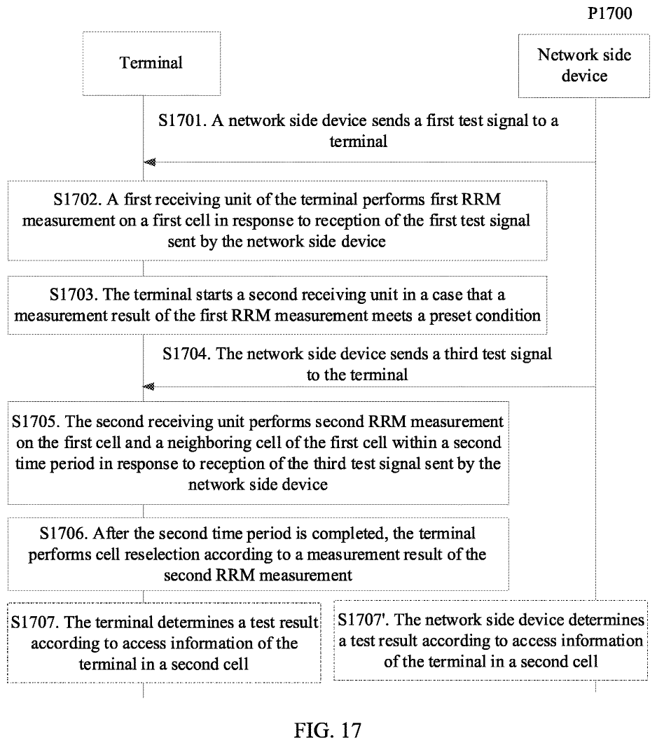

Based on the foregoing embodiment, Embodiment 14 of this application provides an RRM measurement performance test method. This embodiment is used to describe signaling interaction between a terminal and a network side device in a positioning process. FIG. 17 is a signaling flowchart of an RRM measurement performance test method P1700 according to Embodiment 14 of this application. As shown in FIG. 17, the RRM measurement performance test method P1700 provided in this embodiment includes the following steps.
S1701. A network side device sends a first test signal to a terminal.
S1702. A first receiving unit of the terminal performs first RRM measurement on a first cell in response to reception of the first test signal sent by the network side device.
S1703. The terminal starts a second receiving unit in a case that a measurement result of the first RRM measurement meets a second preset condition.
S1704. The network side device sends a third test signal to the terminal.
S1705. The second receiving unit performs second RRM measurement on the first cell and a neighboring cell of the first cell within a second time period in response to reception of the third test signal sent by the network side device.
S1706. After the second time period is completed, the terminal performs cell reselection according to a measurement result of the second RRM measurement.
S1707. The terminal determines a test result according to access information of the terminal in a second cell; or S1707′. The network side device determines a test result according to access information of the terminal in a second cell.

A specific implementation of the embodiment provided in the method P1700 is the same as the specific implementation of the method P600 or the method P1200, and details are not described herein again.

### Embodiment 15

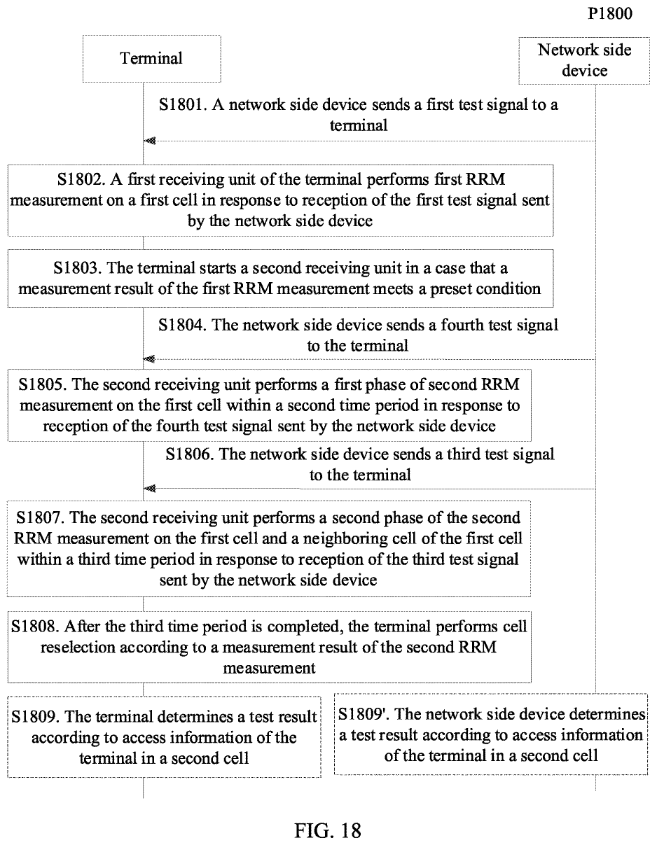

Based on the foregoing embodiment, Embodiment 15 of this application provides an RRM measurement performance test method. This embodiment is used to describe signaling interaction between a terminal and a network side device in a positioning process. FIG. 18 is a signaling flowchart of an RRM measurement performance test method P1800 according to Embodiment 15 of this application. As shown in FIG. 18, the RRM measurement performance test method P1800 provided in this embodiment includes the following steps.
S1801. A network side device sends a first test signal to a terminal.
S1802. A first receiving unit of the terminal performs first RRM measurement on a first cell in response to reception of the first test signal sent by the network side device.
S1803. The terminal starts a second receiving unit in a case that a measurement result of the first RRM measurement meets a second preset condition.
S1804. The network side device sends a fourth test signal to the terminal.
S1805. The second receiving unit performs a first phase of second RRM measurement on the first cell within a second time period in response to reception of the fourth test signal sent by the network side device.
S1806. The network side device sends a third test signal to the terminal.
S1807. The second receiving unit performs a second phase of the second RRM measurement on the first cell and a neighboring cell of the first cell within a third time period in response to reception of the third test signal sent by the network side device.
S1808. After the third time period is completed, the terminal performs cell reselection according to a measurement result of the second RRM measurement.
S1809. The terminal determines a test result according to access information of the terminal in the second cell; or S1809′. The network side device determines a test result according to access information of the terminal in the second cell.

A specific implementation of the embodiment provided in the method P1800 is the same as the specific implementation of the method P700 or the method P1300, and details are not described herein again.

### Embodiment 16

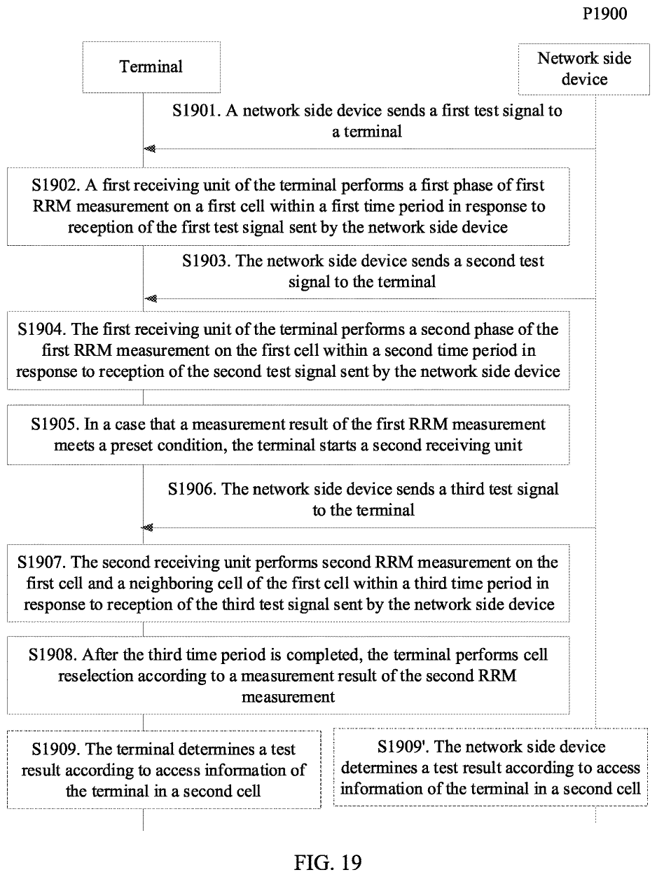

Based on the foregoing embodiment, Embodiment 16 of this application provides an RRM measurement performance test method. This embodiment is used to describe signaling interaction between a terminal and a network side device in a positioning process. FIG. 19 is a signaling flowchart of an RRM measurement performance test method P1900 according to Embodiment 16 of this application. As shown in FIG. 19, the RRM measurement performance test method P1900 provided in this embodiment includes the following steps.
S1901. A network side device sends a first test signal to a terminal.
S1902. A first receiving unit of the terminal performs a first phase of first RRM measurement on a first cell within a first time period in response to reception of the first test signal sent by the network side device.
S1903. The network side device sends a second test signal to the terminal.
S1904. The first receiving unit of the terminal performs a second phase of the first RRM measurement on the first cell within a second time period in response to reception of the second test signal sent by the network side device.
S1905. The terminal starts a second receiving unit in a case that a measurement result of the first RRM measurement meets a second preset condition.
S1906. The network side device sends a third test signal to the terminal.
S1907. The second receiving unit performs second RRM measurement on the first cell and a neighboring cell of the first cell within a third time period in response to reception of the third test signal sent by the network side device.
S1908. After the third time period is completed, the terminal performs cell reselection according to a measurement result of the second RRM measurement.
S1909. The terminal determines a test result according to access information of the terminal in the second cell; or S1909′. The network side device determines a test result according to access information of the terminal in the second cell.

A specific implementation of the embodiment provided in the method P1900 is the same as the specific implementation of the method P800 or the method P1400, and details are not described herein again.

### Embodiment 17

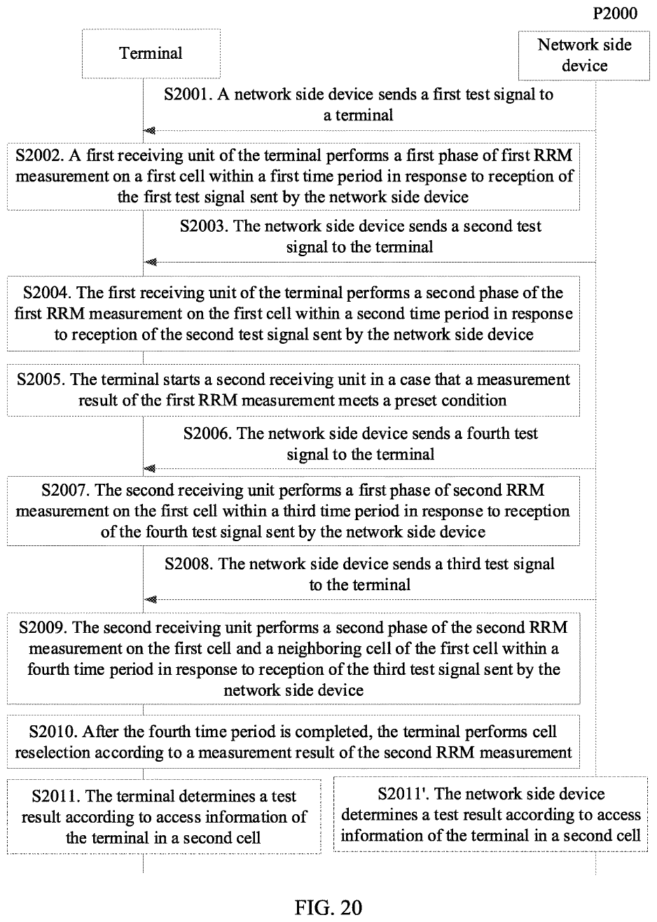

Based on the foregoing embodiment, Embodiment 17 of this application provides an RRM measurement performance test method. This embodiment is used to describe signaling interaction between a terminal and a network side device in a positioning process. FIG. 20 is a signaling flowchart of an RRM measurement performance test method P2000 according to Embodiment 17 of this application. As shown in FIG. 20, the RRM measurement performance test method P2000 provided in this embodiment includes the following steps.
S2001. A network side device sends a first test signal to a terminal.
S2002. A first receiving unit of the terminal performs a first phase of first RRM measurement on a first cell within a first time period in response to reception of the first test signal sent by the network side device.
S2003. The network side device sends a second test signal to the terminal.
S2004. The first receiving unit of the terminal performs a second phase of the first RRM measurement on the first cell within a second time period in response to reception of the second test signal sent by the network side device.
S2005. The terminal starts a second receiving unit in a case that a measurement result of the first RRM measurement meets a second preset condition.
S2006. The network side device sends a fourth test signal to the terminal.
S2007. The second receiving unit performs a first phase of second RRM measurement on the first cell within a third time period in response to reception of the fourth test signal sent by the network side device.
S2008. The network side device sends a third test signal to the terminal.
S2009. The second receiving unit performs a second phase of the second RRM measurement on the first cell and a neighboring cell of the first cell within a fourth time period in response to reception of the third test signal sent by the network side device.
S2010. After the fourth time period is completed, the terminal performs cell reselection according to a measurement result of the second RRM measurement.
S2011. The terminal determines a test result according to access information of the terminal in the second cell; or S2011′. The network side device determines a test result according to access information of the terminal in the second cell.

A specific implementation of the embodiment provided in the method P2000 is the same as the specific implementation of the method P900 or the method P1500, and details are not described herein again.

### Embodiment 18

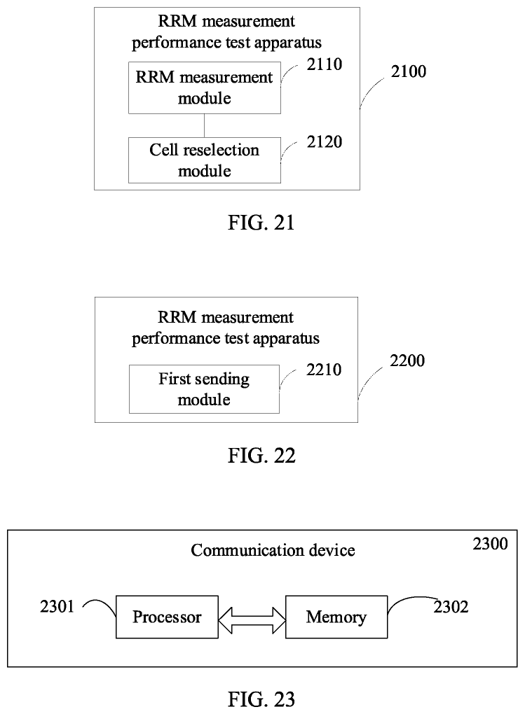

To facilitate better implementation of the RRM measurement performance test method in the embodiments of this application, an embodiment of this application further provides an RRM measurement performance test apparatus. The RRM measurement performance test apparatus may be applied to a terminal. FIG. 21 is a schematic structural diagram of an RRM measurement performance test apparatus 2100 according to Embodiment 18 of this application. As shown in FIG. 21, the RRM measurement performance test apparatus 2100 provided in this embodiment includes the following modules:
an RRM measurement module 2110 and a cell reselection module 2120, where the RRM measurement module 2110 is configured to perform first RRM measurement on a first cell in response to a first receiving unit of a terminal receiving a test signal sent by a network side device, where an operating power of the first receiving unit meets a first preset condition; and the cell reselection module 2120 is configured to: in a case that a measurement result of the first RRM measurement meets a second preset condition, start, by the terminal, a second receiving unit, and perform second RRM measurement by using the second receiving unit so as to perform cell reselection, where access information of the terminal in a second cell is used to determine a test result of RRM measurement performance of the terminal.

In some embodiments, based on the foregoing solution, the first cell is a cell on which the terminal camps when the first RRM measurement is performed, and the second cell is a neighboring cell of the first cell.

In some embodiments, based on the foregoing solution, the RRM measurement module 2110 is specifically configured to perform the first RRM measurement within a first time period in response to the first receiving unit of the terminal receiving a first test signal sent by the network side device.

In some embodiments, based on the foregoing solution, the RRM measurement module 2110 is specifically configured to: perform a first phase of the first RRM measurement within a first time period in response to the first receiving unit of the terminal receiving a first test signal sent by the network side device; and perform a second phase of the first RRM measurement within a second time period in response to the first receiving unit of the terminal receiving a second test signal sent by the network side device, where at least one type of information differs between the first test signal and the second test signal: a transmit power and a signal-to-noise ratio.

In some embodiments, based on the foregoing solution, types of the first test signal and the second test signal each include at least one of the following: a low power wake-up signal LP-WUS or a low power synchronization signal LP-SS.

In some embodiments, based on the foregoing solution, the apparatus 2100 further includes a starting module.

The starting module is configured to start, by the terminal, the second receiving unit in a case that the measurement result of the first RRM measurement meets the second preset condition; the RRM measurement module 2110 is further configured to perform the second RRM measurement on the first cell and the neighboring cell of the first cell within the second time period in response to the second receiving unit receiving a third test signal sent by the network side device; and the cell reselection module 2120 is specifically configured to: after the second time period is completed, perform, by the terminal, cell reselection according to a measurement result of the second RRM measurement.

In some embodiments, based on the foregoing solution, the apparatus 2100 further includes a starting module.

The starting module is configured to start, by the terminal, the second receiving unit in a case that the measurement result of the first RRM measurement meets the second preset condition; the RRM measurement module 2110 is further configured to: perform a first phase of the second RRM measurement on the first cell within the second time period in response to the second receiving unit receiving a fourth test signal sent by the network side device, and perform a second phase of the second RRM measurement on the first cell and the neighboring cell of the first cell within a third time period in response to the second receiving unit receiving a third test signal sent by the network side device; and the cell reselection module 2120 is specifically configured to: after the third time period is completed, perform, by the terminal, cell reselection according to a measurement result of the second RRM measurement.

In some embodiments, based on the foregoing solution, the apparatus 2100 further includes a starting module.

The starting module is configured to start, by the terminal, the second receiving unit in a case that the measurement result of the first RRM measurement meets the second preset condition; the RRM measurement module 2110 is further configured to perform the second RRM measurement on the first cell and the neighboring cell of the first cell within a third time period in response to the second receiving unit receiving a third test signal sent by the network side device; and the cell reselection module 2120 is specifically configured to: after the third time period is completed, perform, by the terminal, cell reselection according to a measurement result of the second RRM measurement.

In some embodiments, based on the foregoing solution, the apparatus 2100 further includes a starting module.

The starting module is configured to start, by the terminal, the second receiving unit in a case that the measurement result of the first RRM measurement meets the second preset condition; the RRM measurement module 2110 is further configured to: perform a first phase of the second RRM measurement on the first cell within a third time period in response to the second receiving unit receiving a fourth test signal sent by the network side device, and perform a second phase of the second RRM measurement on the first cell and the neighboring cell of the first cell within a fourth time period in response to the second receiving unit receiving a third test signal sent by the network side device; and the cell reselection module 2120 is specifically configured to: after the fourth time period is completed, perform, by the terminal, cell reselection according to a measurement result of the second RRM measurement.

In some embodiments, based on the foregoing solution, the foregoing apparatus further includes a determining module. The determining module is configured to: obtain a number of accesses on a random access channel RACH initiated by the second receiving unit within preset duration after the second cell is camped on, and determine the test result of the RRM measurement performance of the terminal according to the number of accesses.

In some embodiments, based on the foregoing solution, the second receiving unit is in a power-off state or a sleep state in a process in which the first receiving unit performs the first RRM measurement on the first cell.

In some embodiments, based on the foregoing solution, the first receiving unit determines the foregoing test signal in a preset detection manner, and the preset detection manner includes at least one of the following: a sequence detection manner, a threshold detection manner, or a payload detection manner.

In some embodiments, based on the foregoing solution, the terminal is in a radio resource control RRC idle mode or an RRC inactivate mode.

It should be understood that the RRM measurement performance test apparatus embodiment provided in Embodiment 18 may correspond to the method embodiment executed by the terminal. For similar description, refer to the method embodiment. To avoid repetition, details are not described herein again.

### Embodiment 19

To facilitate better implementation of the RRM measurement performance test method in the embodiments of this application, an embodiment of this application further provides an RRM measurement performance test apparatus. The RRM measurement performance test apparatus may be applied to a network side device. FIG. 22 is a schematic structural diagram of an RRM measurement performance test apparatus 2200 provided in Embodiment 17 of this application. As shown in FIG. 22, the RRM measurement performance test apparatus 2200 provided in this embodiment includes the following modules:
a sending module 2210, where the sending module 2210 is configured to send, by a network side device, a test signal to a terminal, so that a first receiving unit of the terminal performs first RRM measurement on a first cell in response to reception of the test signal, where an operating power of the first receiving unit meets a first preset condition; and in a case that a measurement result of the first RRM measurement meets a second preset condition, the terminal starts a second receiving unit, and performs second RRM measurement by using the second receiving unit so as to perform cell reselection, where access information of the terminal in a second cell is used to determine a test result of RRM measurement performance of the terminal.

In some embodiments, based on the foregoing solution, the first cell is a cell on which the terminal camps when the first RRM measurement is performed, and the second cell is a neighboring cell of the first cell.

In some embodiments, based on the foregoing solution, the sending module 2210 is specifically configured to send, by the network side device, a first test signal to the terminal, so that the first receiving unit of the terminal performs the first RRM measurement within a first time period in response to reception of the first test signal.

In some embodiments, based on the foregoing solution, the sending module 2210 is specifically configured to: send, by the network side device, a first test signal to the terminal, so that the first receiving unit of the terminal performs a first phase of the first RRM measurement within a first time period in response to reception of the first test signal; and send, by the network side device, a second test signal to the terminal, so that the first receiving unit of the terminal performs a second phase of the first RRM measurement within a second time period in response to reception of the second test signal, where at least one type of information differs between the first test signal and the second test signal: a transmit power and a signal-to-noise ratio.

In some embodiments, based on the foregoing solution, types of the first test signal and the second test signal each include at least one of the following: a low power wake-up signal LP-WUS or a low power synchronization signal LP-SS.

In some embodiments, based on the foregoing solution, the terminal starts the second receiving unit in a case that the measurement result of the first RRM measurement meets the second preset condition; and the apparatus 2200 further includes a second sending module.

The second sending module is configured to send a third test signal, so that the second receiving unit of the terminal performs the second RRM measurement on the first cell and the neighboring cell of the first cell within the second time period in response to reception of the third test signal.

In some embodiments, based on the foregoing solution, the terminal starts the second receiving unit in a case that the measurement result of the first RRM measurement meets the second preset condition; and the apparatus 2200 further includes a second sending module.

The second sending module is configured to: send a fourth test signal, so that the second receiving unit of the terminal performs a first phase of the second RRM measurement on the first cell within the second time period in response to reception of the fourth test signal; and send a third test signal, so that the second receiving unit of the terminal performs a second phase of the second RRM measurement on the first cell and the neighboring cell of the first cell within a third time period in response to reception of the third test signal.

In some embodiments, based on the foregoing solution, the terminal starts the second receiving unit in a case that the measurement result of the first RRM measurement meets the second preset condition; and the apparatus 2200 further includes a second sending module.

The second sending module is configured to send a third test signal, so that the second receiving unit of the terminal performs the second RRM measurement on the first cell and the neighboring cell of the first cell within a third time period in response to reception of the third test signal.

In some embodiments, based on the foregoing solution, the terminal starts the second receiving unit in a case that the measurement result of the first RRM measurement meets the second preset condition; and the apparatus 2200 further includes a second sending module.

The second sending module is configured to: send a fourth test signal, so that the second receiving unit of the terminal performs a first phase of the second RRM measurement on the first cell within a third time period in response to reception of the fourth test signal; and send a third test signal, so that the second receiving unit of the terminal performs a second phase of the second RRM measurement on the first cell and the neighboring cell of the first cell within a fourth time period in response to reception of the third test signal.

In some embodiments, based on the foregoing solution, the apparatus 2200 further includes a determining module. The determining module is configured to: obtain a number of accesses on a random access channel RACH initiated by the second receiving unit within preset duration after the second cell is camped on, and determine the test result of the RRM measurement performance of the terminal according to the number of accesses.

It should be understood that, the RRM measurement performance test apparatus embodiment provided in Embodiment 19 may correspond to the method embodiment executed by the network side device. For similar description, refer to the method embodiment. To avoid repetition, details are not described herein again.

The RRM measurement performance test apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal. The another device may be a server, a network attached storage (Network Attached Storage, NAS), or the like. This is not specifically limited in this embodiment of this application.

### Embodiment 20

As shown in FIG. 23, an embodiment of this application further provides a communication device 2300, including a processor 2301 and a memory 2302. The memory 2302 stores a program or instruction that can be run on the processor 2301. For example, when the communication device 2300 is a terminal, the program or instruction is executed by the processor 2301 to implement steps of the foregoing RRM measurement performance test method in any one of the embodiments shown in FIG. 3 to FIG. 9, and a same technical effect can be achieved. When the communication device 2300 is a network side device, the program or instruction is executed by the processor 2301 to implement all steps of the foregoing RRM measurement performance test method in any one of the embodiments shown in FIG. 10 to FIG. 15, and a same technical effect can be achieved. To avoid repetition, details are not described herein again.

### Embodiment 21

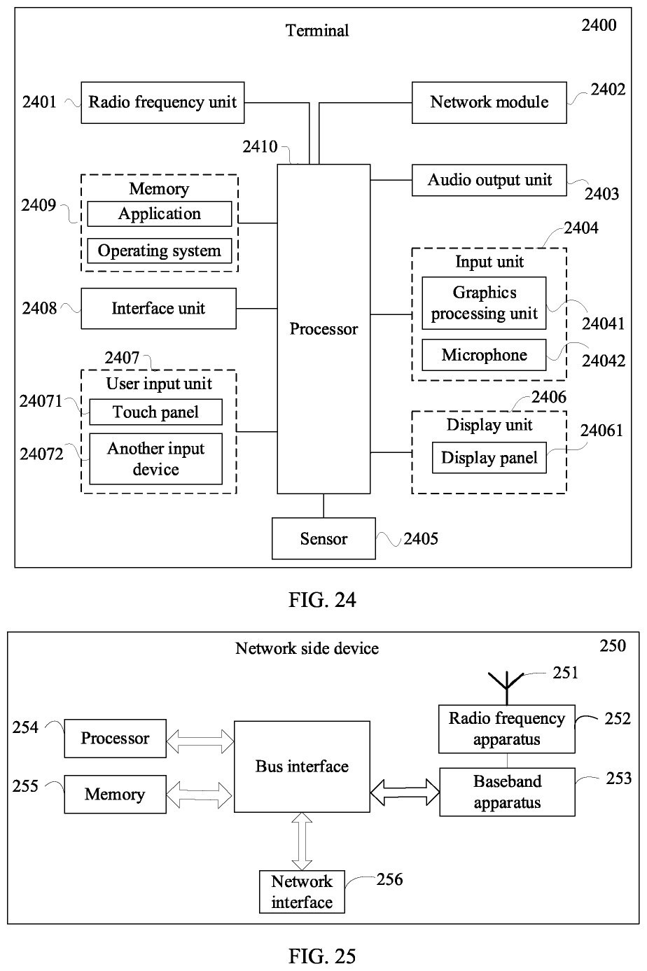

An embodiment of this application further provides a terminal, including a processor and a communication interface. The communication interface is coupled to the processor, and the processor is configured to run a program or an instruction to implement the steps of the method embodiment shown in any one of FIG. 3 to FIG. 9. This terminal embodiment corresponds to the foregoing method embodiment on the terminal side. Each implementation process and implementation of the foregoing method embodiment may be applicable to this terminal embodiment, and a same technical effect can be achieved. Specifically, FIG. 24 is a schematic structural diagram of hardware of a terminal according to an embodiment of this application.

The terminal 2400 includes but is not limited to a part of components such as a radio frequency unit 2401, a network module 2402, an audio output unit 2403, an input unit 2404, a sensor 2405, a display unit 2406, a user input unit 2407, an interface unit 2408, a memory 2409, and a processor 2410.

A person skilled in the art can understand that the terminal 2400 may further include the power supply (for example, a battery) that supplies power to each component. The power supply may be logically connected to the processor 2410 by using a power supply management system, so as to manage functions such as charging, discharging, and power consumption by using the power supply management system. The terminal structure shown in FIG. 24 constitutes no limitation on the terminal, and the terminal may include more or fewer components than those shown in the figure, or combine some components, or have different component arrangements. Details are not described herein.

It should be understood that, in this embodiment of this application, the input unit 2404 may include a Graphics Processing Unit (GPU) 24041 and a microphone 24042, and the graphics processing unit 24041 processes image data of a still image or a video that is obtained by an image capturing apparatus (for example, a camera) in a video capturing mode or an image capturing mode. The display unit 2406 may include a display panel 24061. The display panel 24061 may be configured in a form such as a liquid crystal display or an organic light-emitting diode. The user input unit 2407 includes at least one of a touch panel 24071 or another input device 24072. The touch panel 24071 is also referred to as a touchscreen. The touch panel 24071 may include two parts: a touch detection apparatus and a touch controller. The another input device 24072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 2401 may transmit the downlink data to the processor 2410 for processing. In addition, the radio frequency unit 2401 may send uplink data to the network side device. Usually, the radio frequency unit 2401 includes but is not limited to an antenna, an amplifier, a transceiver, a coupler, a low noise amplifier, a duplexer, and the like.

The memory 2409 may be configured to store a software program or an instruction and various data. The memory 2409 may mainly include a first storage area for storing a program or an instruction and a second storage area for storing data. The first storage area may store an operating system, and an application or an instruction required by at least one function (for example, a sound playing function or an image playing function). In addition, the memory 2409 may include a volatile memory or a non-volatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a Random Access Memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synch link DRAM, SLDRAM), and a direct rambus random access memory (Direct Rambus RAM, DRRAM). The memory 2409 in this embodiment of this application includes but is not limited to these memories and a memory of any other proper type.

The processor 2410 may include one or more processing units. Optionally, an application processor and a modem processor are integrated into the processor 2410. The application processor mainly processes an operating system, a user interface, an application, and the like. The modem processor mainly processes a wireless communication signal, for example, a baseband processor. It can be understood that, alternatively, the modem processor may not be integrated into the processor 2410.

The processor 2410 is configured to: control the first receiving unit to: perform first RRM measurement on a first cell in response to reception of a test signal sent by a network side device, where an operating power of the first receiving unit meets a first preset condition; and in a case that a measurement result of the first RRM measurement meets a second preset condition, start a second receiving unit, and perform second RRM measurement by using the second receiving unit so as to perform cell reselection, where access information of the terminal in a second cell is used to determine a test result of RRM measurement performance of the terminal.

The terminal is deployed with the first receiving unit whose operating power meets the first preset condition. In a case that the network side sends the test signal to the terminal, the first receiving unit performs the first RRM measurement on the first cell, to reduce power consumption of the terminal. In a case that the measurement result of the first RRM measurement meets the second preset condition, the terminal starts the second receiving unit, and performs the second RRM measurement by using the second receiving unit so as to perform cell reselection. Further, the access information of the terminal in the second cell may be used to determine the test result of the RRM measurement performance of the terminal. For example, that the terminal successfully accesses the second cell indicates that the first receiving unit successfully wakes up the second receiving unit in the RRM measurement process. It can be learned that this embodiment of this application can provide a performance test scheme for behavior that a low power receiver wakes up a primary receiver.

It can be understood that, for an implementation process of each implementation mentioned in this embodiment, reference may be made to the related descriptions of any one of FIG. 3 to FIG. 9, and a same or corresponding technical effect is achieved. To avoid repetition, details are not described herein again.

### Embodiment 22

An embodiment of this application further provides a network side device, including a processor and a communication interface. The communication interface is coupled to the processor, and the processor is configured to run a program or an instruction to implement the steps of the method embodiment shown in any one of FIG. 10 to FIG. 15. This network side device embodiment corresponds to the foregoing method embodiment on the network side device. Each implementation process and implementation of the foregoing method embodiment may be applicable to this network side device embodiment, and a same technical effect can be achieved.

Specifically, an embodiment of this application further provides a network side device. As shown in FIG. 25, the network side device 2500 includes an antenna 251, a radio frequency apparatus 252, a baseband apparatus 253, a processor 254, and a memory 255. The antenna 251 is connected to the radio frequency apparatus 252. In an uplink direction, the radio frequency apparatus 252 receives information by using the antenna 251, and sends the received information to the baseband apparatus 253 for processing. In a downlink direction, the baseband apparatus 253 processes information that needs to be sent, and sends processed information to the radio frequency apparatus 252. The radio frequency apparatus 252 processes the received information, and sends processed information by using the antenna 251.

In the foregoing embodiment, the method performed by the network side device may be implemented in the baseband apparatus 253. The baseband apparatus 253 includes a baseband processor.

The baseband apparatus 253 may include, for example, at least one baseband board, where a plurality of chips are disposed on the baseband board. As shown in FIG. 25, one chip, for example, the baseband processor, is connected to the memory 255 through a bus interface, to invoke a program in the memory 255 to perform the operations of the network device shown in the foregoing method embodiment.

The network side device may further include a network interface 256, and the interface is, for example, a Common Public Radio Interface (CPRI).

Specifically, the network side device 2500 in this embodiment of the present invention further includes an instruction or a program that is stored in the memory 255 and that can be run on the processor 254. The processor 254 invokes the instruction or the program in the memory 255 to execute the method executed by the modules shown in any one of FIG. 10 to FIG. 15, and a same technical effect is achieved. To avoid repetition, details are not described herein again.

### Embodiment 23

An embodiment of this application further provides a readable storage medium. The readable storage medium stores a program or an instruction, and the program or the instruction is executed by a processor to implement the processes of the foregoing RRM measurement performance test method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc. In some examples, the readable storage medium may be a non-transient readable storage medium.

### Embodiment 24

An embodiment of this application further provides a chip. The chip includes a processor and a communication interface, the communication interface is coupled to the processor, and the processor is configured to run a program or an instruction to implement the processes of the foregoing RRM measurement performance test method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

### Embodiment 25

An embodiment of this application provides a computer program/program product. The computer program/program product is stored in a storage medium, and the computer program/program product is executed by at least one processor to implement the processes of the foregoing RRM measurement performance test method embodiment, and a same technical effect can be achieved. To avoid repetition, details are not described herein again.

### Embodiment 26

An embodiment of this application further provides an RRM measurement performance test system, including a terminal and a network side device. The terminal may be configured to perform the steps of the RRM measurement performance test method in any one of FIG. 3 to FIG. 9, and the network side device may be configured to perform the steps of the RRM measurement performance test method in any one of FIG. 10 to FIG. 15.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by computer software product in addition to a necessary general hardware platform or by hardware. The computer software product is stored in a storage medium (for example, a ROM, a RAM, a magnetic disk, or an optical disc) and includes several instructions, so that the terminal or the network side device executes the RRM measurement performance test methods provided in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms of implementations without departing from the purpose of this application and the protection scope of the claims, all of which fall within the protection of this application.

1. A radio resource management RRM measurement performance test method, comprising:
performing, by a first receiving unit of a terminal, first RRM measurement on a first cell in response to reception of a test signal sent by a network side device, wherein an operating power of the first receiving unit meets a first preset condition; and
in a case that a measurement result of the first RRM measurement meets a second preset condition, starting, by the terminal, a second receiving unit, and performing second RRM measurement by using the second receiving unit so as to perform cell reselection, wherein
access information of the terminal in a second cell is used to determine a test result of RRM measurement performance of the terminal.

2. The method according to claim 1, wherein the first cell is a cell on which the terminal camps when the first RRM measurement is performed, and the second cell is a neighboring cell of the first cell.

3. The method according to claim 1, wherein the performing, by a first receiving unit of a terminal, first RRM measurement on a first cell in response to reception of a test signal sent by a network side device comprises:
performing, by the first receiving unit of the terminal, the first RRM measurement within a first time period in response to reception of a first test signal sent by the network side device.

4. The method according to claim 1, wherein the performing, by a first receiving unit of a terminal, first RRM measurement on a first cell in response to reception of a test signal sent by a network side device comprises:
performing, by the first receiving unit of the terminal, a first phase of the first RRM measurement within a first time period in response to reception of a first test signal sent by the network side device; and
performing, by the first receiving unit of the terminal, a second phase of the first RRM measurement within a second time period in response to reception of a second test signal sent by the network side device, wherein
at least one type of information differs between the first test signal and the second test signal: a transmit power and a signal-to-noise ratio.

5. The method according to claim 4, wherein types of the first test signal and the second test signal each comprise at least one of the following: a low power wake-up signal LP-WUS or a low power synchronization signal LP-SS.

6. The method according to claim 4, wherein the first receiving unit determines the first test signal and the second test signal in a preset detection manner, and the preset detection manner comprises at least one of the following: a sequence detection manner, a threshold detection manner, or a payload detection manner.

7. The method according to claim 3, wherein the method further comprises:
starting, by the terminal, the second receiving unit in a case that the measurement result of the first RRM measurement meets the second preset condition;
performing, by the second receiving unit, the second RRM measurement on the first cell and the neighboring cell of the first cell within the second time period in response to reception of a third test signal sent by the network side device; and
after the second time period is completed, performing, by the terminal, cell reselection according to a measurement result of the second RRM measurement.

8. The method according to claim 3, wherein the method further comprises:
starting, by the terminal, the second receiving unit in a case that the measurement result of the first RRM measurement meets the second preset condition;
performing, by the second receiving unit, a first phase of the second RRM measurement on the first cell within the second time period in response to reception of a fourth test signal sent by the network side device;
performing, by the second receiving unit, a second phase of the second RRM measurement on the first cell and the neighboring cell of the first cell within a third time period in response to reception of a third test signal sent by the network side device; and
after the third time period is completed, performing, by the terminal, cell reselection according to a measurement result of the second RRM measurement.

9. The method according to claim 4, wherein the method further comprises:
starting, by the terminal, the second receiving unit in a case that the measurement result of the first RRM measurement meets the second preset condition;
performing, by the second receiving unit, the second RRM measurement on the first cell and the neighboring cell of the first cell within a third time period in response to reception of a third test signal sent by the network side device; and
after the third time period is completed, performing, by the terminal, cell reselection according to a measurement result of the second RRM measurement.

10. The method according to claim 4, wherein the method further comprises:
starting, by the terminal, the second receiving unit in a case that the measurement result of the first RRM measurement meets the second preset condition;
performing, by the second receiving unit, a first phase of the second RRM measurement on the first cell by using the second receiving unit within a third time period in response to reception of a fourth test signal sent by the network side device;
performing, by the second receiving unit, a second phase of the second RRM measurement on the first cell and the neighboring cell of the first cell within a fourth time period in response to reception of a third test signal sent by the network side device; and
after the fourth time period is completed, performing, by the terminal, cell reselection according to a measurement result of the second RRM measurement.

11. The method according to claim 1, wherein the method further comprises:
after the terminal camps on the second cell, obtaining a number of accesses on a random access channel RACH initiated by the second receiving unit within preset duration; and
determining the test result of the RRM measurement performance of the terminal according to the number of accesses.

12. The method according to claim 1, wherein the second receiving unit is in a power-off state or a sleep state in a process in which the first receiving unit performs the first RRM measurement on the first cell.

13. The method according to claim 1, wherein the terminal is in a radio resource control RRC idle mode or an RRC inactivate mode.

14. A radio resource management RRM measurement performance test method, comprising:
sending, by a network side device, a test signal to a terminal, so that a first receiving unit of the terminal performs first RRM measurement on a first cell in response to reception of the test signal, wherein an operating power of the first receiving unit meets a first preset condition; and
in a case that a measurement result of the first RRM measurement meets a second preset condition, the terminal starts a second receiving unit, and the terminal performs second RRM measurement by using the second receiving unit so as to perform cell reselection, wherein access information of the terminal in a second cell is used to determine a test result of RRM measurement performance of the terminal.

15. The method according to claim 14, wherein the first cell is a cell on which the terminal camps when the first RRM measurement is performed, and the second cell is a neighboring cell of the first cell.

16. The method according to claim 14, wherein the sending, by a network side device, a test signal to a terminal comprises:
sending, by the network side device, a first test signal to the terminal, so that the first receiving unit of the terminal performs the first RRM measurement within a first time period in response to reception of the first test signal.

17. The method according to claim 14, wherein the sending, by a network side device, a test signal to a terminal comprises:
sending, by the network side device, a first test signal to the terminal, so that the first receiving unit of the terminal performs a first phase of the first RRM measurement within a first time period in response to reception of the first test signal; and
sending, by the network side device, a second test signal to the terminal, so that the first receiving unit of the terminal performs a second phase of the first RRM measurement within a second time period in response to reception of the second test signal, wherein
at least one type of information differs between the first test signal and the second test signal: a transmit power and a signal-to-noise ratio.

18. The method according to claim 14, wherein the method further comprises:
obtaining, by the network side device, a number of accesses on a random access channel RACH initiated by the second receiving unit within preset duration after the terminal camps on the second cell; and
determining the test result of the RRM measurement performance of the terminal according to the number of accesses.

19. A terminal, comprising a processor and a memory, wherein the memory stores a program or an instruction that can be run on the processor, and the program or the instruction is executed by the processor to implement a radio resource management RRM measurement performance test method, the method comprising:
performing, by a first receiving unit of the terminal, first RRM measurement on a first cell in response to reception of a test signal sent by a network side device, wherein an operating power of the first receiving unit meets a first preset condition; and
in a case that a measurement result of the first RRM measurement meets a second preset condition, starting, by the terminal, a second receiving unit, and performing second RRM measurement by using the second receiving unit so as to perform cell reselection, wherein
access information of the terminal in a second cell is used to determine a test result of RRM measurement performance of the terminal.

20. A network side device, comprising a processor and a memory, wherein the memory stores a program or an instruction that can be run on the processor, and the program or the instruction is executed by the processor to implement the steps of the radio resource management RRM measurement performance test method according to claim 14.
